(19) United States
(12) Patent Application Publication
(10) Pub. No.: US 2006/0201148 A1
(43) Pub. Date: Sep. 14, 2006

(54) Hydraulic-compression power cogeneration system and method

(76) Inventor: Fikret M. Zabtcioglu, Bellevue, WA (US)

Correspondence Address: Dean A. Craine, Suite 140, 400 - 112th Avenue Northeast, Bellevue, WA, 98004, US

(21) Appl. No.: 11/118,243

(22) Filed: Apr. 28, 2005

Related U.S. Application Data
(63) Continuation-in-part of application No. 11/006,351, filed on Dec. 7, 2004.

(51) Int. Cl. F02G 1/04

(52) U.S. Cl. 60/508

(57) ABSTRACT

A system and method for converting kinetic energy into useable thermal energy by means of a gas compression based cogeneration. Kinetic forces applied, that are coupled to kinetic components of electro-mechanic thrusters 3, 49-input side, and upper small area pistons 7, 53-receiving side transmitted by shafts 4 and 50 get multiplied through Pascal hydraulic oil links 16 and 17, that are between the lower side small area pistons 12, 58 and lower side large area pistons 21, 60. At least two compression chambers are used to compress gas therein repeatedly to increase the pressure and temperature of the same. Auxiliary compressors 41, 73 help to increase temperature of compressed gas further. Said heat generated is conducted into a single liquid sodium thermal storage volume 36 that facilitates a highly stable thermal storage volume and contains working gas spiral sections 35, 39 circulating within. Steam 113 generated within spiral sections 35, 39 generates power in turbines 99, 106 and then heat residential and/or commercial buildings 115. Service hot-water is provided utilizing a water tank 85 and refrigerant coil circulation oil volume 92, both utilize thermal storage volume 36 waste heat by conduction for a triple integrated system. The system may also be combined with other power generation systems. In second embodiment 121 with more than two units of compression chambers and higher capacity, low cost electric power generated enables efficient hydrogen mass production. A thermo-physical cogeneration system with central heating means, and a cogeneration power plant 121 with hydrogen mass production and hydrogen storage capabilities; are presented as what are new in the art.

This is a continuation in part application of U.S. patent application (Ser. No. 11/006,351) filed on Dec. 7, 2004.

### BACKGROUND OF THE INVENTION

1. Field of the Invention

The present invention relates to cogeneration systems, and more particularly to cogeneration systems with central heating. The heating system is combined with a chilled-water central air conditioner to provide an integrated triple system with air conditioning, steam based central heating and service hot-water. A second embodiment relates to a plant of cogeneration power generation and hydrogen mass production capabilities.

2. Description of the Related Art

Housing apartment units and multi-family units usually use a central heat source such as a boiler or a forced-air system using gas fired or electric resistance furnaces for space heating. Forced air is very inefficient—as it heats the space disproportionately and air is an unstable medium that cools down very quickly, especially as compared to water or steam based systems for example. Individual units of gas or oil furnaces, electric heat pumps, or electric resistance heating systems are also in widespread use. These systems are energy inefficient.

In order to solve these problems of energy inefficiencies, different methods have been proposed. For example, a heating system is disclosed to provide an improvement in the combined configuration for better efficiency, by Talbert et al (U.S. Pat. No. 6,109,339) that discloses a triple integrated system to provide room air heating, and cooling and domestic hot water.

With respect to cogeneration and to be able to respond to a plurality of different demands of thermal energy, a cogeneration system apparatus is disclosed by Togawa, et al (U.S. Pat. No. 6,290,142) that includes an improvement in hot-water storage and re-heating of hot-water, that enables it to respond to two different thermal loads.

With respect to space heating, combustion gases from direct air heating are used to heat a water tank. Doherty (U.S. Pat. No. 2,354,507) and Biggs (U.S. Pat. No. 5,361,751) both use warm combustion gases for the space heating, to heat potable water in a water tank. Due to the need for dual burners, such systems are large size and therefore are costlier. Other devices are referred to as instantaneous heaters that heat potable water with direct heat exchange from combustion gases. Clawson (U.S. Pat. No. 5,046,478) uses a combustion gas heat exchanger to heat a potable water to be used for air heating. It is stored in a water tank for the service hot-water. Woodin (U.S. Pat. No. 4,848,416) discloses an instantaneous heat exchanger. These systems that are based on the conventional combustion to provide heat for space heating as well as service hot-water heating and are inefficient. These require large combustion gas to working gas and/or hot-water exchangers in order to satisfy high loads. The instantaneous systems are very energy inefficient and require ignition and switching devices. Lower durability is a common problem with these systems.

The demand for highly efficient and low cost cogeneration is increasing on a world-wide basis. In the last decade of the century, about 100 billion watts of new electric generating capacity will be needed in the U.S. and 500 GW(e) more will be needed overseas.

Unless there is a technology shift, a very conservative estimate predicts that world-wide power related CO2 emission would rise at least by 60% from 1997 by 2020. Therefore, European Union Commission aims to double the contribution of combined heating and power (CHP) solutions from 9% to 18% by 2010.

The hydrogen economy, among other variables, requires that hydrogen to be produced at the lowest cost possible. World consumption of hydrogen currently is 50 million tons per year, with an anticipated growth of at least 10% per year. In U.S.A., the production of 11 million tons of hydrogen/per year, consumes 5% of U.S. natural gas usage. The total of all U.S. transportation needs would require about 200 million tons of hydrogen per year. Each year, 17 million vehicles are manufactured in the U.S., further increasing the energy demand. These figures indicate the fact that there is already a hydrogen economy and it has a growth trend. The hydrogen fuel economy requires a primary energy source that can provide thermal energy and other energy types derived from thermal energy at the lowest cost possible and hydrogen being produced as the portable energy carrier. Therefore, a reliable and low cost primary thermal energy source that is also environment friendly is imperative.

Since certain distribution standards have become standard, increases in efficiency in a standard size cogeneration system is possible either by increasing the density of energy on a given system and heat transfer area of a central heating unit, or by finding a lower cost and more efficient energy, that is, to have a lower cost of energy source, or a combination of low cost energy source and technical innovation. The trend indicates that the focus is on renewable energy systems.

The technologies involved in cogeneration and central heating products and thermal processes generally are in one of the following categories:

a. technologies that pertain to a primary specific energy source, such as a fossil fuel, natural gas or coal, b. technologies that deal with renewable systems, c. technologies that pertain to the design of the heat exchange systems that serves as an efficient heat transfer, and; d. technologies that pertain to the control of waste heat, cogeneration and turbo-feedback.

Among the most important central heating performance measurements are:

a. thermal load density that is preferably high, and; b. the annual load factor; that is high. A high load density is needed in order to cover the capital investment of the transmission and distribution system that constitutes the majority of the capital cost. The yearly load factor is important because the total system is capital intensive. Therefore, central heating systems are more applicable to:

1. Industrial complexes, 2. Densely populated urban areas, 3. High density building clusters with high thermal loads. District-central heating is best suited for areas that have high building and population densities—where the climate is cold, 4. Where efficiency of insulation can be maximized. As in new construction or existing residential and/or commercial premises that are suitable for good insulation.

Combined heating and power (CHP) users usually have the following demands:

1. Capital cost that is low: Power and heat generation are needed to support some major industrial processes and are usually capital intensive. Hence, it is preferable to have a relatively low investment cost and have a short period for realizing return on investment.

2. Continuous availability and high reliability: Most industrial processes demand continuity of operation. Therefore, reliable and easy to maintain systems are required.

3. Life cycle cost that is low: The primary reason for the investment in CHP is the high efficiency and the associated long term cost savings.

4. Short completion and delivery time: CHP plant systems can be designed for a relatively short system construction time that may also retrofit to existing plants.

5. Customization approach: The demand for power and heat are usually based on site specific needs. Therefore, standardized plants can be scaled for the specific needs.

Reliability and long term low operational cost are the two major priorities for end users. Therefore, different renewable energy systems and arrangements have been proposed.

Prior art cogeneration and central heating systems developed are of two main types: Those that are based on a conventional combustion means with high energy density and related heat transfer mechanisms and those that are based on a renewable energy source with a relatively low energy density. The energy output as a result of any type burning process—with high energy density is costlier; as fossil fuels are scarce. Although the energy density of the renewable source is not as high as the fossil fuels, an improved technology can compensate for the lower energy density of the renewable source. An improved, non-combustion and fossil fuel independent technology is the main focus of this invention.

Space heating and cooling use 46% of all energy consumed in U.S. residential buildings. Service water-heating accounts for an additional 14%. This is a very high total of 60% for residential heating, service water and cooling needs only. That is, 60% of all energy consumed is of low energy quality type of utilization. For example, electricity converted to heat in an electrical resistance heater is an example to low quality energy utilization. Whereas, an example to high energy quality utilization, are devices like computers, in which electrical energy is not converted for the purpose of thermal energy.

Operational cost is related to three issues: 1. Energy type; fossil fuel-burner type or renewable type, 2. Heat transfer. Among various causes, the main causes of energy losses are the lack of a highly thermally stable reservoir that can establish a long term internal heat stabilization medium. For example, a thermally stable volume—for which less energy would be needed to keep it stable at a certain temperature range in the long run, despite of utilizing a low density energy of a renewable energy source and, 3. Insulation type and efficiency.

4. Cogeneration-CHP Efficiency.

Former central heating and cogeneration systems do not have a means to generate energy that can multiply the energy input and utilize a renewable energy source most of the time, resulting in a non-combustion, zero-emission, zero waste products system. As a result, a means of a very low cost electricity and heat generation can be achieved. A search in this field indicated that there is no prior art directly germane to the present invention.

### SUMMARY OF THE INVENTION

From the foregoing, it may be appreciated that a need has arisen for a system and method for a cogeneration system and triple integrated system with air conditioning, central heating and service hot-water that avoids energy inefficiencies of the prior art.

It is thus an object of the present invention to provide cogeneration apparatus capable of supplying thermal energy efficiently to satisfy a plurality of different energy demands.

As a first feature of the invention, the system can have operational input energy from a renewable energy source and can also obtain operational energy from utility grid. Likewise, the system can be paralleled to the utility grid for electrical energy output-sale.

As a second feature of the present invention, at least one pair of electro-mechanic thrusters provide force for kinetic motion to push steel shafts, that are coupled to said thrusters at one side, and one pair of first small area pistons in the pair of piston/cylinder combinations, are coupled to said shafts at the other end of said shafts; connected to first small area upper piston sides. As a third feature of the invention, said first small area piston/cylinder combinations are connected through hydraulic links to large area pistons in the second large area piston/cylinder combinations, that include thermo-physical energy generators consisting of at least two large area pistons of piston/cylinder combinations of units A and B that are working in coordination in compression-decompression cycles.

As a fourth feature of the invention, the decompression task is aided by external pressure regulation units that periodically communicate gas out from and into the compression chambers, in order to avoid vacuum formations within the compression chambers during decompressions.

As a fifth feature of the invention, the large area pistons multiply the energy input by at least three fold and thereby uses the energy input most efficiently by increasing the energy input that is provided by the small area piston sides, and the compressed and heated gas supply thermal energy that is obtained by compressing a gas repeatedly within said compression chambers. As a sixth feature of the invention, thermal energy is directly conducted through the enlarged area dome heat conduction interfaces, into; a single thermal storage volume of liquid sodium, that is within a cylindrical container; thus establishes a highly stable thermal storage reservoir that enables high efficiency capacity utilization within a much shorter time than it takes for prior art systems to reach their most efficient system capacity utilization. Usually, most efficient operational capacity factor utilization is possible only after a very long time of power load period. For example, in a nuclear plant this is three years. In nuclear plants, long construction times and very high initial investment expenses make return on investment within only few years impossible.

As a seventh feature of the invention, wherein at least one pair of spiral working gas pipe sections of a closed cycle working gas circulation line; are circulated within the single thermal storage volume for heat exchange-conduction means.

As an eighth feature of the present invention, part of the gas volumes of which the temperatures are increased in compression chambers in units A and B, through compression; are communicated through valves periodically into at least two auxiliary compression volumes, wherein gas volumes are further compressed and the temperature further increases and this heat is also conducted into the single thermal storage volume through the auxiliary compressor steel interface heat transfer sections that are located within the thermal storage volume, and the heated gas volumes within auxiliary volumes are then returned as feedback gas into the said compression volumes to provide a higher pre-compression gas temperature.

As a ninth feature of the present invention, at least one pair of steam turbines utilize the high temperature-pressure steam generated within the spiral sections to produce electrical energy, and working gas passing the turbines is circulated and utilized for central heating of residential and/or commercial premises.

As a tenth feature of the present invention, at least one pair of pre-heater units are provided to heat the returning working gas to avoid heat shock as it enters thermal storage volume. As an eleventh feature of the invention, a service hot water storage tank that heats service hot water and a hot oil storage tank for drawing heat to heat the refrigerant coils that are circulated therein, both tanks are heated by waste heat from the thermal storage volume, to provide a triple integrated system that provides high system efficiency throughout all seasons.

As a twelfth feature of the present invention, bypass pipes and valves enable optimal distribution of working gas between the steam turbine electrical energy generation means and the central heating working gas distribution means.

As a thirteenth feature of the present invention, thermal storage volume enables flexibility of using different types of thermal storage materials that can be used and that are easy to maintain, overhaul, drain out, change and refill.

In the second embodiment, as fourteenth feature of the present invention, invention enables hydrogen mass production by providing very low cost electrical as well as thermal energy for various hydrogen generation means, including several safe hydrogen storage means.

As a fifteenth feature, invention system provides a high reliability cogeneration system that does not depend on fossil fuels, coal, natural gas or nuclear energy for the generation of primary heat source, all of which are non-renewable, therefore makes the invention system independent of additional costs of pollution control and fossil fuel price jumps and/or severe shortages and thus unsustainable in the long run.

As a sixteenth feature, invention system achieves a minimized waste heat system and therefore, provides a zero heat pollution system.

As a seventeenth feature, invention system enables high energy quality utilization. The invention system enables the thermal energy generated to be utilized directly as thermal energy where it is needed; for central heating, and electricity generated is not converted back to thermal energy for heating needs.

As a eighteenth feature of the invention system, invention provides a power cogeneration system that is highly flexible in terms of size and capacity scaling; where the system can be an independent, decentralized larger auto-production or total energy type of system for factories, hospitals, university campuses, military installations or commercial complexes or a group of residential buildings, or small size and capacity unit for a single apartment unit or single family house.

As a nineteenth feature of this invention of cogeneration system, of which the rated capacity to run on the highest capacity factor operation condition, is independent of external variables and constraints like seasonal changes, day-night energy cycles—large areas needed for installation; as in solar systems, weather conditions—large areas for installation; as in wind turbines, and scarcity and pollution of fossil or nuclear fuels; as in combustion and nuclear plants respectively, or availability of sufficient water levels in artificial lakes that have to flood land; as it is for hydroelectric dams.

As an twentieth feature of the invention, a wear-resistant cogeneration system that by eliminating fuel oil, coal or natural gas burning, and by making use of a frictionless material, makes it possible to have a system of long-lived plant.

As a twenty-first feature of the present invention, for first and second embodiments to provide a cogeneration system with a second embodiment hydrogen mass production means, which are subject of a low cost OEM production and can be compatible to existing central-district residential and/or commercial heating and/or power generation, with regards to technical means and labor, and accordingly is then subject of reasonable prices of sale to the consuming and operating entities and public, thereby makes the said cogeneration-central heating and the second embodiment of cogeneration of electricity and hydrogen production plant to provide significant economic gains to the energy end-use sectors, as well as a relatively fast return on investment to the power utility investors.

As a twenty-second feature of the invention, a third embodiment provides OEM power generation, thermal processing engineering companies the flexibility of choosing different means to integrate various energy conversion and generation means or use the thermal energy for other industrial processes that can utilize the thermo-physical energy base of this invention.

These and other objects of the present invention will be more evident as depicted by the drawings.

### DESCRIPTION OF THE DRAWINGS

FIG. 1. is a cross sectional depiction of the entire system that is made of two units A and B that are united at one common thermal liquid sodium storage volume 36. It shows the renewable energy electrical input 1—for units A and B, and to secure uninterrupted operational energy, the system is also connected to electrical input from the utility grid that may be a non-renewable energy source 2—for units A and B. The electro-mechanic thruster component 3 (unit A at decompression reversed position,) and electro-mechanic thruster 49 (unit B at compressed thruster position,) the steel shaft 4 that is moved by the electro-mechanic thruster 3, steel shafts 4 of unit A and thruster 49 and shaft 50 of unit B have the function to provide regularly kinetic force and thereby to suddenly move the first small area pistons upper sides 7 (A) and upper side 53 (B) respectively, and lower sides 12 and 58 (unit A) and first large area piston lower side 21 and upper side 26 (unit A), that move within small area cylinder 5 (unit A) and large area cylinder 18 (unit A) and transmit the forces applied to the hydraulic oil 16 (unit A) and hydraulic oil 17 (unit B.) In this drawing the steel shaft 4 (A) that gets moved by thruster 3 (A) is not moved by the electro-mechanic thruster component 3 yet, and therefore hydraulic oil 16 of unit A has not transmitted the force applied by the first piston lower side 12, yet. Large area piston lower side 21 and air tight upper side 26, is also at the pre-compression position—for the unit A. By air tight, it is to be understood that the large area upper side pistons 21 and 66 fully compress the gas enclosed in volumes above these and do not let gas to escape to any other area. All of the triple integrated system components and sections—as integrated and located around the thermal storage volume 36, steel enclosure frames 34, also depicted.

FIG. 2. is a cross sectional view of the system unit A, shows the motion of the steel shaft 4 and shows how the force applied by the first small area piston lower side 12 gets multiplied at the larger area upper side compression piston 26, via the hydraulic oil 16, (Initial adiabatic heating of compressed gas 30 in compression chamber 28 of unit A.)

FIG. 3 is a cross sectional view of the system unit A, shows how the small area piston upper side 7 and lower side 12, therefore large area piston upper 26 and lower side 21 are re-positioned back to the initial pre-compression position by the reversal of the thrust motion direction of the electro-mechanic thruster component 3, and thereby the steel shaft 4 makes the small area piston upper side 7, and hence lower side 12 to move to the decompressed gas 29 position.

FIG. 4 is an cross sectional view of unit A of the compression side, showing how, after the gas volume 29 gets compressed into gas volume 30, heat conduction wait period starts, during which the gas 30 remains in an iso-volumetric state and heat is conducted into the single combined thermal storage liquid sodium volume 36 through the concave steel interface 31 of units A (same method applies to B,) during this time. The high pressure working gas 113 circulation exit pipe 97 out of unit A that leads into the steam turbine 99, which on the two sides has, two bypass pipes 100 and 101, with one switch valve 98 that is on pipe 97(A) and valves 102, 103 on bypass pipes 100 and 101.

FIG. 5. is a cross sectional view of the system unit A, (unit B is identical,) it shows how, as heat conduction period described in FIG. 4 ends, in order to avoid a vacuum effect in volume 28 and also to provide the gas to be compressed within the auxiliary compression volume 46, before the compression large area piston upper side 26 returns to the full pre-compression position 29 and makes gas volume 30 to be decompressed back to gas volume 29, how an equal gas volume is transferred into auxiliary volume 46 and concurrently an equal gas volume gets supplied into volume 28 from the external pressure regulation volume unit (A) 129, through the pressure regulation and gas input-output valve 127.

FIG. 6. is a cross sectional view of unit A, shows how the high temperature feedback gas 126 entry from the auxiliary compressor 41 that passes through input-output valve 47 and is re-supplied into the compression chamber 28 as decompressed motion ½ through.

FIG. 7. in cross sectional view of unit A, thermal storage volume 36, A side, shows one of the triple integrated system components of service hot water tank 85 and sections—as integrated and located around the left half of the thermal storage volume 36 steel enclosure cylindrical surface area 87. The working gas 113 steam spiral pipe section 35 that circulates within the liquid sodium volume 36, and then reach the radiators 114 at the centrally heated residential and/or commercial buildings 115, radiators 114 and buildings 115 shown on top.

FIG. 8. is a cross sectional depiction of the system unit A thermal storage 36, that shows the hydrogen electrolysis and high-temperature steam hydrogen generation and the metal hydride means of hydrogen storage means unit 120 and the second embodiment unit B side (that consist of the combination of units A and B combined, as in FIG. 1,) of the cogeneration power generation plant 121 for electricity generation and mass production of hydrogen.

FIG. 9. is an illustration in plan view of the plant systems, each consisting of unit A and B, where a multiple number of plants, in a network setup, several units of cogeneration plants 118 and 119, complement each other in a closed cycle distribution for high capacity and wide area applications. Units A and B are identical, same relations apply in FIGS. 2-9 on side B.

FIG. 10. is an illustrative depiction of the large area piston upper 26 and lower sides 21 and the sequence of the cycle of compressions and decompressions that is based on four compressions per cycle. The gas input-output relations with the auxiliary compression volume 46 and with the external pressure regulation unit volume 139, is illustrated.

### LIST OF REFERENCE NUMERALS USED

1. Operational electricity input from a renewable source (For both units A and B),
2. Operational electricity input from the utility grid (Units A, B),
3. Electro-mechanic thruster (A),
4. Steel shaft of the electro-mechanic thruster 3 (A),
5. Small area cylinder (A),
6. Small area cylinder internal surface area frictionless layer (A),
7. Small area piston upper side (A),
8. Steel shaft connecting upper and lower sides of small area piston-upper and lower pistons and shaft being one uniform structure (A),
9. Fixed platform shaft opening—small area piston side (A),
10. Fixed platform shaft internal frictionless layer—small area piston side (A),
11. Fixed platform between the upper and lower sides of the small area pistons—that also functions as a stopper for both upper and lower side small area pistons (A),
12. Small area piston lower side (A),
13. Small area piston surface area facing the hydraulic oil (A),
14. Hydraulic oil pipe connecting small area cylinder and lower side small area piston with large area cylinder and lower side large area piston (A),
15. Hydraulic oil pipe connecting small area cylinder and lower side small area piston with large area cylinder and lower side large area piston (B),
16. Hydraulic oil (Of unit A),
17. Hydraulic oil (Of unit B),
18. Large area cylinder (A),
19. Large area cylinder internal frictionless layer (A),
20. Large area piston lower side surface area facing the hydraulic oil (A),
21. Large area piston lower side (A),
22. Steel shaft connecting upper and lower sides of large area pistons—upper and lower pistons and steel shaft being one uniform structure (A),
23. Fixed platform between the upper and lower sides of large area pistons—that also functions as a stopper for both upper and lower side large area pistons (A),
24. Fixed platform shaft opening—large area side (A),
25. Fixed platform shaft hole internal frictionless layer—large area side (A),
26. Large area piston upper side (A),
27. Large area piston upper side surface area facing the compression chamber (A),
28. Compression chamber (A),
29. Compression chamber gas volume in the fully decompressed state (A),
30. Compression chamber gas volume in fully compressed state with 1/21 compression ratio (A),
31. Heat conduction concave steel interface (A),
32. External insulation layer frame (A and B),
33. Internal semi-insulation layer facing the service hot water volume 89 and refrigerant gas coil heating oil volume 92 (A and B),
34. Thermal storage liquid sodium volume steel enclosure frame (A and B combined),
35. Working gas pipe spiral section (A),
36. Thermal storage liquid sodium volume (A and B combined as one),
37. Thermal storage liquid sodium volume drainage valve,
38. Thermal storage liquid sodium volume filling pipe,
39. Working gas pipe spiral section (B),
40. Auxiliary compressor electro-mechanic thruster (A),
41. Auxiliary compressor (A),
42. Auxiliary compressor tube steel skin (A),
43. Auxiliary compressor internal frictionless layer (A),
44. Auxiliary compressor piston shaft (A),
45. Auxiliary compressor piston (A),
46. Auxiliary compression volume (A),
47. Auxiliary compressor gas input-output valve (A),
48. Auxiliary compressor gas input-output pipe (A),
49. Electro-mechanic thruster (B),
50. Steel shaft of the electro-mechanic thruster (B),
51. Small area cylinder (B),
52. Small area cylinder frictionless layer (B),
53. Small area piston upper side (B),
54. Steel shaft connecting upper and lower sides of small area pistons—pistons and shaft being one uniform structure (B),
55. Fixed platform shaft opening (B),
56. Fixed platform shaft hole internal frictionless layer (B),
57. Fixed platform between upper and lower sides of small area pistons—that also has stoppers for both upper and lower side small area pistons (B),
58. Small area piston lower side (B),
59. Small area piston lower side surface area facing the hydraulic oil (B),
60. Large area piston lower side (B),
61. Steel shaft connecting upper and lower sides of large area pistons—pistons and shaft being one uniform structure (B),
62. Fixed platform between upper and lower sides of large area pistons that also has stoppers for both upper and lower side pistons (B),
63. Fixed platform shaft opening—large area (B),
64. Large area cylinder (B),
65. Large area cylinder internal frictionless layer (B),
66. Large area piston upper side (B),
67. Large area piston upper side-surface area facing the compression chamber (B),
68. Compression chamber (B),
69. Compression gas volume in the fully compressed state with 1/21 compression ratio (B),
70. Compression gas in the fully decompressed state (B),
71. Heat conduction concave steel interface (B),
72. Auxiliary compressor electro-mechanic thruster (B),
73. Auxiliary compressor (B),
74. Auxiliary compressor external tube steel skin (B),
75. Auxiliary compressor internal frictionless layer (B),
76. Auxiliary compressor piston shaft (B),
77. Auxiliary compressor piston (B),
78. Auxiliary compressor compression volume (B),
79. Auxiliary compressor gas input-output valve (B),
80. Auxiliary compressor gas input-output pipe (B),
81. Working gas return pipe (A),
82. Pre-heater unit (A);
83. Working gas return pipe (B),
84. Pre-heater unit (B),
85. Service hot water steel tank-left side that is around ½ of the total cylinder surface area of the thermal storage volume steel enclosure circumference (A),
86. Pre-heater unit for service hot water volume input (A),
87. Thermal storage volume steel enclosure frame 34—cylinderical external surface area that faces the semi-insulation layer (Same on A and B),
88. Service hot water circulation outgoing pipe (A),
89. Service hot water temperature regulation mixer unit-outgoing (A),
90. Service hot water tank-water input pipe (A),
91. Refrigerant gas (Of freon-12 or dichlorodifluoromethane type, which boils at −29.8 C),
92. Refrigerant gas coil heating oil volume—right side that is around ½ of the total cylindrical surface area of the thermal storage volume steel enclosure circumference (B),
93. Refrigerant gas heater spiral coil section within volume 92 (B),
94. Refrigerant dissipation coils (B),
95. Refrigerant gas heater spiral exiting volume 92 (B),
96. Refrigerant gas heater spiral entering volume 92 (B),
97. Working gas exiting thermal storage volume (A),
98. Switch and pressure buildup regulation valve on pipe 97 (A),
99. Steam turbine (A),
100. Bypass pipe 1 (A),
101. Bypass pipe 2 (A),
102. Bypass pipe 1-valve (A),
103. Bypass pipe 2-valve (A),
104. Working gas pipe exiting thermal storage volume (B),
105. Switch and pressure buildup regulation valve on pipe 104 (B),
106. Steam turbine (B),
107. Bypass pipe 1 (B),
108. Bypass pipe 2 (B),
109. Bypass pipe 1-valve (B),
110. Bypass pipe 2-valve (B),
111. Working gas closed cycle district heating circulation pipe-past turbine 99 (A),
112. Working gas closed cycle district heating circulation pipe-past turbine 106 (B),
113. High pressure working gas (Same for units A & B),
114. Radiators (Same in A and B),
115. Residential and/or commercial buildings,
116. Central air conditioning chilled water unit (B),
117. Chilled water unit outgoing pipe (B side only,)
118. Cogeneration plant 1 in the multiple plant configuration,
119. Cogeneration plant 2 in the multiple plant configuration,
120. Hydrogen electrolysis and hydrogen generation and hydrogen storage unit of 121,
121. Cogeneration plant with electricity and hydrogen mass production capability (Second embodiment,)
122. Booster pump for circulating the return condensed working fluid back to the spiral pipe section,
123. Auxiliary compressor-steel interface heat transfer section (A),
124. Auxiliary compressor-steel interface heat transfer section (B),
125. Refrigerant gas 91 pump (B side only),
126. Compressed gas within the auxiliary compression volume 46 (A) and 78 (A),
127. Compression chamber 28-pressure regulation and gas input-output valve that communicates with volume 129 and avoids vacuum effect while de-compressing (A),
128. Compression chamber 68-pressure regulation and gas input-output valve that communicates with volume 130 and that avoids vacuum effect during decompressing (B),
129. External pressure regulation volume unit and compressor (A),
130. External pressure regulation volume unit and compressor (B),
131. Refrigerant gas 91-expansion valve (B side only),
132. Chilled water unit cooler coils (B side only),
133. Large area piston lower side 60 upper surface area, facing the hydraulic oil (B),
134. External pressure regulation volume gas input-output pipe (A),
135. External pressure regulation volume gas input-output pipe (B),
136. Booster pump for circulating the returning condensed working fluid back into the spiral pipe section and throughout the closed cycle circulation line (B),
137. Working gas closed cycle circulation district heating pipes 111 and 112 united in a single pipe,
138. Chilled water returning pipe (B side only),
139. External pressure regulation unit internal volume (A),
140. External pressure regulation unit internal volume (B),
141. A pair of durable and flexible stoppers for small area piston upper side 7, that are on the upper two sides of the fixed platform 11 (A),
142. A pair of durable and flexible stoppers for small area piston lower side 12, that are under the two sides of the fixed platform 11 (A),
143. A pair of durable and flexible stoppers for large area piston 26, that are on the upper two sides of the fixed platform 23 (A),
144. A pair of durable and flexible stoppers for large area piston lower side 21, that are under the two sides of the fixed platform 23 (A),
145. Same type of pair of stoppers as in 141, for small area piston upper side 53, that are on the two sides of the fixed platform 57 (B),
146. Same type of pair of stopper as in 142, for small area piston lower side 58, that are under two sides of the fixed platform 57 (B),
147. Same type of pair of stoppers as in 143, for large area piston upper side 66, that are on the upper two sides of the fixed platform 62 (B),
148. Same type of pair of stoppers as in 144, large area piston lower side 60, that is under the two sides of the fixed platform 62 (B),
149. Secondary hydrogen generation device that uses natural gas.

### DESCRIPTION OF THE PREFERRED EMBODIMENT(S)

This invention is based on the following principles of physics:

1. The non-compressibility of fluids in an enclosed container with oil, especially the Pascal hydraulic which is a force multiplier device;

2. Compressibility of gases, especially of a gas of low density and high compressibility (Initially adiabatic, then iso-volumetric.) An industrial gas mixture of which the temperature can be increased adiabatically to said high temperatures and has better thermal stability-slower cooling, can be applied instead of air for higher efficiency;

3. High temperature thermal storage reservoir that, depending on the engineering choices and material availability would consist of one of the following: A static oil volume of hydrocarbon or carbon-tetrachloride type fluid, or molten nitrate salt or combined molten salt and oil/rock, or liquid sodium or sodium chloride or one similar chemical variant that is highly stable and durable under continuous high temperature and have high average heat conductivity and high specific heat capacity.

The heat conduction and heat transfer means is as follows:

a. The pre-compression volume of gas 29 that is enclosed in the compression chamber 28, of which the temperature increases 30 fold each and every time it is compressed and becomes the compressed gas volume 30. Once in the compressed gas state 30, direct heat conduction occurs through the heat conduction steel interface 31 of which thermal conductivity is increased through a strengthened steel-alloy feature and an enlarged area due to the dome surface interface 31 area, that is ½ surface area of a sphere.

Thus, based on the basic heat transfer equation applied to a heat exchanger, first equation:
q=UA(Ta−Tb) (1)

Where q is the rate of transfer, U the overall transfer coefficient, A the surface area for heat transfer, and (Ta−Th) the average temperature difference. The area A is enlarged by the dome surface area that is ½ of a sphere, hence rate of heat transfer increases; b. The thermal storage liquid sodium 36 is not circulated to any other area. This establishes a highly stable heat reservoir 36, that does not go through phase changes and always remains fluid; c. The spiraling pipe section 35 within this liquid sodium volume 36, that is also made of steel and hence has good thermal conductivity—where heat transfer is again by conductivity from the liquid sodium 36 that surrounds the spiral pipe section 35 within which the steam-working gas 113 is generated; d. The hot-service water tank volume 85, that utilizes thermal storage volume 36 waste heat, with semi-insulation layer 33 that is around the liquid sodium volume steel enclosure 34, cylindrical wall external surface area 87, and faces the semi-insulation layer 33 that covers the thermal storage liquid sodium volume 36 that is enclosed within the steel enclosure frame 34, and water is stabilized at 75 degrees (C) in volume 85, and utilizes waste heat from the internal liquid sodium volume 36; e. A service hot water temperature regulator unit 89 for outgoing service hot water, that avoids water temperatures above a pre-selected upper threshold of about 65 degrees (C), is utilized for heated water output for shower, dish-washing, washing machine or other appliances; f. Air conditioner refrigerant heating section internal coil spiral 93 that runs within the oil tank 92, that contains an oil stabilized at 70 degrees (C), likewise surrounds the other ½ of the external surface area 87 of the liquid sodium volume 36 of the cylindrical steel enclosure frame 34, and also utilizes the waste heat from the liquid sodium volume 36, through the semi-insulation layer 33; g. two hot gas feedback auxiliary compressors 41 and 73 and their compression volumes 46 and 78 that provide hot feedback gas 126 to the pre-compressed gas 29 and 70, that have pistons 45 and 77 that move within frictionless layers (NFC) 43 and 75, electro-mechanic thrusters 40 and 72 are the thrusters of auxiliary compressors 41 and 73.

Following second formula explains the initial adiabatic condition, which results from the sudden compression of the large area compression upper piston 26, compressing and changing the gas volume 29 within the compression chamber 28, to the compressed state 30, with 1/21 compression ratio, if pre-compression gas volume 29 temperature is 40 C and:
5

Pre-compression pressure is 1.0×10 Pa.
0.40
   T2=T1(V1/V2)=(313 K)×(21)=1058 K=785 C. (2)
   (If air with Gamma=1.40 is compressed. Another low density, highly compressible industrial gas can be used to provide higher temperatures and better thermal stability.)

If a relatively small force F1 is applied to the smaller piston 7 of area A1, by the shaft 4 of the invention system, the pressure F1/A1 is transmitted undiminished throughout the confined hydraulic fluid 16. This pressure acting on the large-area piston lower side 21 and upper side 26 of area A2 will exert a total force on it equal to the product of the area A2 times the pressure. Therefore, the third formula explains the relation:
F2=P×A2=F1/A1×A2, rearranged it gives:
F2=A2/A1×F1 (3)

Hence, if the large area piston lower side 21 and upper side 26 have three times the surface area of the small area piston 7, the force that is applied at the small area piston 7 is multiplied by three. If for example, the force applied on small area piston is 4300.0 N then the force applied gets multiplied to 12900.0 N at the large area piston upper side 26. With two units, it adds up to 8600.0 N input and 25800.0 N output as sum of two large area pistons. (Not exact figures; example of proportions.)

The system consists of the following main components, but are not limited to these:

a. at least two sources of renewable energy electricity input connection 1, such as from wind or solar energy, which also can receive electricity from the main electricity grid 2; b. at least two electro-mechanic thrusters 3 and 49; c. at least two steel shafts 4 and 50 that are electro-mechanically moved by 3 and 49, regularly to push the small area piston upper sides 7 and 53, d. at least two pipes 14 and 15 that communicates the hydraulic oil 16 and 17 to the other large diameter piston lower sides 21 and 60; e. at least two other larger diameter pistons upper sides 26 and 66 that have the capability to compress the enclosed gas above, and are moved by the first hydraulic oil 16 and 17 through the lower side large area pistons 21 and 60 and compress at least two gas volumes 29 and 70 above it; f. at least two highly conductive dome steel interfaces 31 and 71 that directly conduct heat generated by the compressions to the stationary thermal storage 36; g. at least one thermal storage liquid sodium volume 36; h. at least two spiraling pipe volumes 35 and 39 that run within said liquid sodium volume 36, where said spiraling pipe sections 35 and 39 attain thermal equilibrium with the thermal storage liquid sodium volume 36; i. at least two high temperature feedback gas 126, and auxiliary compressor volumes 46 and 78 that provide hot feedback gas 126 to the pre-compressed gas 29, with input-output valves 47 and 79; j. at least one service hot-water output pipe line 88 and service hot-water insulated water tank volume 85, service hot-water, water input 90; k. at least two strongly insulated steam distribution pipes 111 and 112 and radiators 114 that are placed within the residential and/or commercial buildings 115; l. at least two steam turbines 99 and 106 of non-condensing-back pressure type that operates basis topping cycle in a cogeneration set up, where the exhaust steam 113 (the working gas 113 numeral is same throughout all its phases within the closed cycle circulation,) is used for central heating; m. at least three hydrogen production means and devices 120, 151 and related systems and means for a plurality of different methods of hydrogen production; n. at least four bypass pipe paths 100 and 101 and 107 and 108 and one switch valve 98 for bypass pipes 100 and 101 and control valves 102 and 103 on 100 and 101, and one switch valve 105 for bypass pipes 107 and 108 and bypass control valves 109 and 110 on 107 and 108; o. at least two pre-heating units 81 and 84 for the returning working gas 113; p. a booster pump 122 for circulating the returning condensed working fluid back to the spiral pipe section 35; q. at least one spiral coils section 93 of refrigerant 91 that runs within an insulated oil tank 92 around ½ of the cylindrical surface area 87 of the thermal storage volume 36 of the system, for a chilled-water central air conditioner cool water storage unit 116 to provide air conditioning. r. at least one chilled water output circulation pipe 117. s. at least two auxiliary compressor heat transfer steel tube interfaces 123 (A) and 124 (B) that are within the thermal storage volume 36 and transfer heat into the thermal storage liquid sodium volume 36. t. at least two external pressure regulation units 127 and 128 and gas-intake valves 129 and 130 to avoid vacuum condition within volumes 28 and 70 during decompressions. u. at least four pairs of durable and flexible stoppers 141, 142, 143, 144, 145, 146, 147 and 148 above and below the fixed platforms of 11, 23, 62.

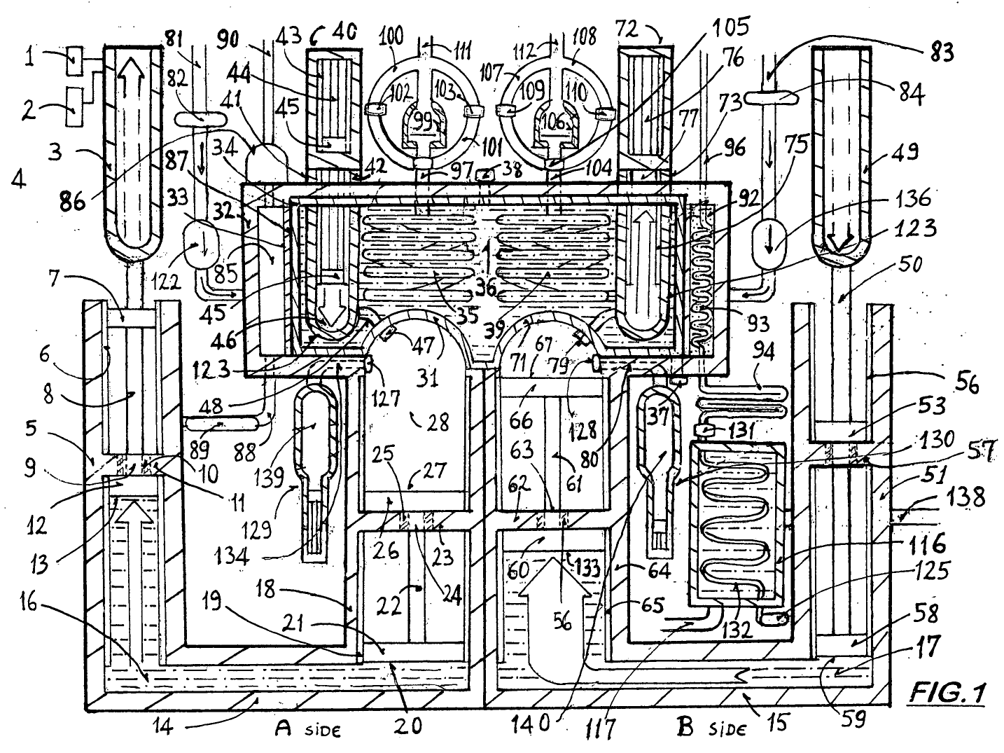

With reference to FIG. 1, the structure with at least four cylinders 5, 18 and 51 and 64 are connected with hydraulic pipes 14 and 15. The electro-mechanic thrusters 3 and 49 get activated in two phases. In the first phase, it starts the kinetic motion slowly and thereby avoids a shock and material wear and tear on the steel shafts 4(A) and 50(B). Then in second phase, kinetic force applied becomes swift and shafts 4 and 50 transmit the kinetic force, of which only electro-mechanic thruster 49 is activated in this figure. Swift motion covers four times greater distance of displacement, as compared to the slow starting distance. The function of the electro-mechanic thrusters 3 and 49 is to provide this two phased kinetic force on a regular basis and thereby to swiftly move the first small area pistons upper sides 7 and 53 that move within small area cylinders 5 and 51 and the hydraulic oil 16 and 17 transmit the force applied. This shows the state before compression of unit A, as unit B is in compressed state.

Again referring to FIG. 1, the frictionless internal surface coatings 6, 19 and 56, 65 are preferably made of the NFC (Near frictionless carbon coating) material. The coefficient of friction of this is less than 0.001 and has very strong wear resistance and durability that reduce material wear and energy losses. Commercial field tests of this material has been started and Argonne National Laboratory works with Front Edge Technology, Inc. (Baldwin Park, Calif.); and Stirling Motors, Inc. (Ann Arbor, Mich.); and Diesel Technology Company (Wyoming, Mich.) to develop the near-frictionless coating to increase efficiency, extend wear life, and reduce maintenance costs. The auxiliary compressor 41 of unit A has an electro-mechanic thruster 40, an external tube steel skin 42 and within this, a frictionless layer 43 made also of (Near frictionless carbon coating.)

Again referring to FIG. 1, this surface coating 6 is for the inner surface of the first small area cylinder 5 and serves for the frictionless gliding of the first small area pistons upper side 7 and lower side 12. The upper and lower sides of the piston 7 and 12 are separated by a fixed platform 11.

Again referring to FIG. 1, the hydraulic oil 16 transmits the force applied by the shaft 4 via piston 12 and confined hydraulic oil 16 undiminished to piston 21 through pipe 14, to compress the gas volume 29 that is enclosed above the upper large area piston 26. Large area upper piston 26 and lower piston 21 are separated by the fixed platform 23. A shaft hole 24 with frictionless layer 25 enables steel shaft 22 to move within. The frictionless coating within large area cylinder 18 and for the large area pistons 21 and 26 is 19. Heat conduction concave steel interfaces 31 and 71 are concave steel interfaces of units A and B respectively. Where the area maximization of these interfaces 31 and 71, is explained by the following fourth formula of surface area of a sphere:
4 Pi×r. squared; one half is therefore;
4 Pi×r. squared/2. (4)

The area of each interface of each 31 and 71 is equal to ½ of the area of surface area of a sphere. Thereby, due to enlarged heat dome conduction interfaces 31 and 71 areas, the quantity of heat flow maximization into the thermal storage 36 is made possible.

Referring to FIG. 1, gas input-output valve 47 is for transferring 50% of the compressed gas 30 at the end of the compressed iso-volumetric state at 300 degrees (C) into auxiliary compression volume 46, where it is further compressed with a compression ratio of 1/17 and thereby the heat of the gas is increased to 1500 degrees (C.)

Referring to FIG. 1 again, the temperature storage volume 36 is a highly stable temperature storage medium that facilitates thermal equilibrium condition with the spiral pipe sections 35 and 39 that circulate therein, which in a topping cycle method, provides the high pressure steam 113 with greater than 1500 psig that is first used to generate power through steam turbines 99 and 106, and then heat the residential and/or commercial buildings 115 that circulates through the radiators 114. A bypass section that has two bypass passage pipes 100 and 101 for the steam turbine 99 with one switch and pressure regulation valve 98 enable pressure buildup as well as; a. a complete bypass of the steam turbine 99, or; b. enable working gas-steam 113 to proceed to the central-district heating closed cycle pipe line 111, while at the same time, part of steam 113 generated goes through the steam turbine 99, or; c. goes straight through turbine 99 first and then proceeds to the closed cycle pipe line 111(A) and 112(B). Thereby, the balance between the power generation and heat generation is made highly flexible. This would provide the flexibility to increase the power or the heat generation, based on the site-specific demands that can change in time. The working gas 113 closed cycle district heating circulation is carried through pipe 111 and 112, pre-heater unit 82 is for increasing the temperature of returning lower temperature-pressure working gas 113, so that it can reach thermal equilibrium within the spiral pipe section 35, within the liquid sodium volume 36 in a short time, the working gas 113 return pipe 82 leads into the volume 36, returning circulated working gas 113 after being pumped by booster pump 122, of which the pumping speed is fully adjustable and usually runs on a slow flow mode, so that there is sufficient time for the working gas 113 to heat up to superheated steam in spiral section 35.

With reference to FIG. 1 again, shown is also the service hot-water outgoing pipe line 88 and service hot-water heat transfer and thermal equilibrium tank 85 that is located around the other ½ cylindrical external surface area 87 of the thermal storage-stability oil volume 36 that is covered with the semi-insulation layer 33. Service hot-water, water input is provided by pipe 90 with pre-heater unit 86.

Referring to FIG. 1, again also shown is air conditioner refrigerant gas coils 93 combined with an air conditioner and chilled-water unit 116 to provide a central air conditioning during summer months. Air conditioner refrigerant heating coil 93 that runs within volume 92 is heated by the waste heat from the steel enclosure surface 87 and semi-insulation layer 33 that are around the liquid sodium volume 36 cylindrical container frame 34. The refrigerant 91 is heated to 70 (C) and its temperature and pressure increases by thermal input. A compressor is used only as an auxiliary and pumping unit 125. The heat dissipation coils 94 allow refrigerant 91 to dissipate its' heat. As it cools, refrigerant 91 condenses into liquid form and goes through an expansion valve 131, the expansion valve 131 enables a low pressure evaporated and cold refrigerant 91 to proceed to the central air conditioning chilled-water unit 116, where it cools water to 4.4 and 7.2 degrees (C.) This chilled water is then piped out with pipes 117 throughout the buildings 115 and connected to the air handlers or to air conditioner units.

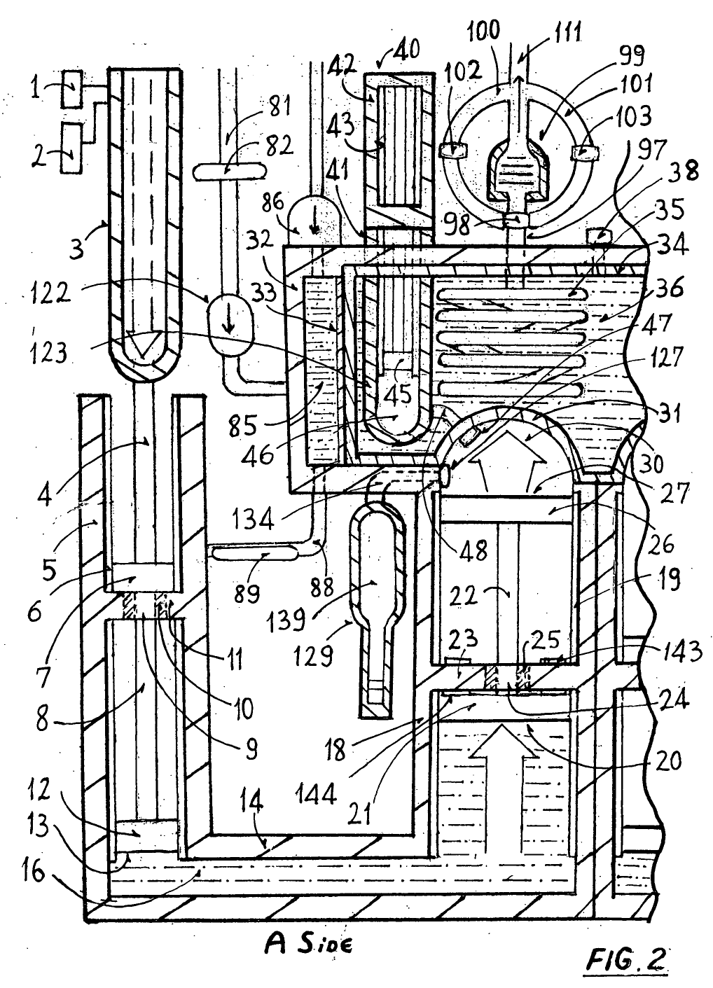

With reference to FIG. 2, of unit A, after small area piston upper side 7 is displaced as it is pushed by the thrust of the electro-mechanic thruster 3, by the steel shaft 4 and provides the thrust that moves the small area piston 7 and hence small area piston lower side 12, and the hydraulic oil 16 transmits the force applied undiminished to the other side of large area compression piston lower side 21 and hence to large area piston upper side 26 that multiplies the force applied by a factor of three above the larger area piston upper side 26 side, where it pressurizes the pre-compression gas 29 enclosed within compression chamber 28 into gas volume 30.

Again referring to FIG. 2, the compressed gas 30 with increased pressure and temperature, initially an adiabatic process for the gas compressed 30, then becomes iso-volumetric; as the volume of the compressed gas state 30 remains compressed but does not change during heat conduction.

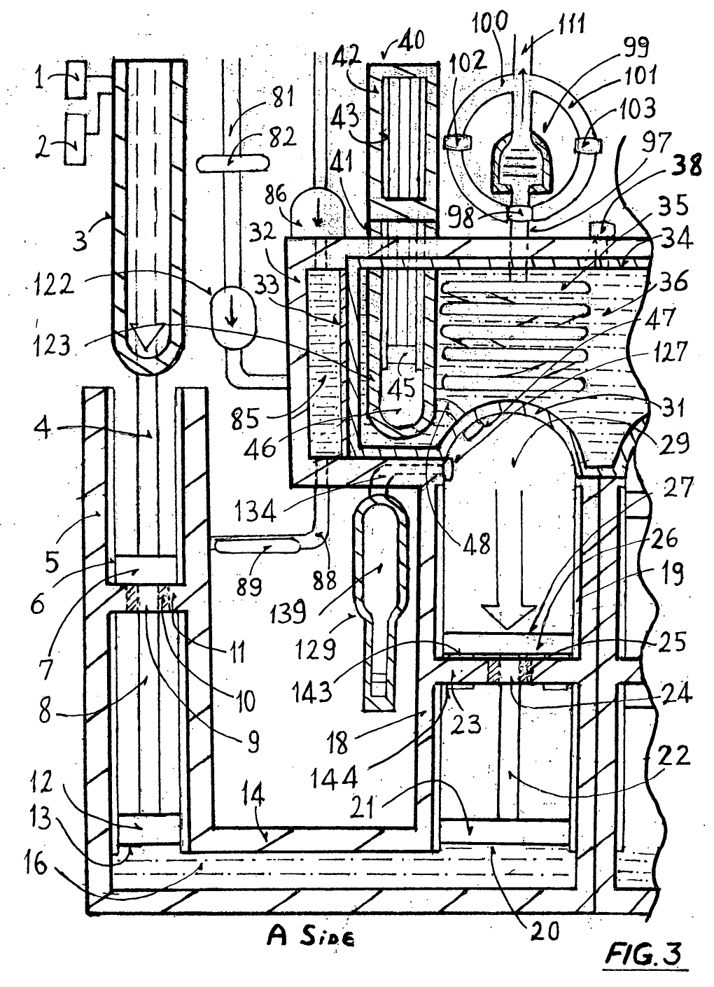

With reference to FIG. 3 depicted in cross sectional view of unit A, is how the system returns to the pre-compression volume 29 state, and as the shaft 4 reverses direction, this time slowly, in order to repeat the sudden thrust so that the first side small area piston upper side 7 can be moved again to the apposite direction and thereby becomes ready for the next thrust. The thermal energy from the compressed gas volume 30 at a temperature of 800-950 (C) is transferred to the heat storage liquid sodium volume 36, with a maximum 6% loss, upper part of piston 26 is non-conducting, but the heat conduction dome steel interface 31, which has both an enlarged area due to the concavity and is also highly heat conductive to maximize thermal conductivity at about 370 W/m. K in SI units, if made of strengthened steel-tungsten alloy. A strong insulation layer 32 insulates the static thermal storage volume 36, preferably made of one internal layer thick steel and one layer of an insulator Styrofoam or a stronger means of insulation.

Again referring to FIG. 3, starting at the end of second compression and lasting the entire second decompression and entire third compression and until third decompression is ½ through, input-output valve 47 remains closed and 50% of the compressed gas that has been transferred into auxiliary volume 46 from volume 28, is further compressed within auxiliary volume 46 and the temperature of the compressed gas 30 is further compressed, that becomes gas volume 126 of which temperature increases to 1500 degrees (C), based on the initial 300 (C) input temperature that gets compressed with a compression ratio of 1/17. Compression of auxiliary volume 46 occurs concurrently at the time of the end of the wait period of the second compression of piston 26, right after valve 47 closes after receiving the gas from volume 28. Therefore, the wait period of compressed auxiliary volume equals to the sum of the durations of second decompression completion and third compression occurring and wait period of piston 26, plus waiting for the third decompression to reach ½ way through, before reaching the fully decompressed position, the feedback gas 126 is supplied into volume 28.

With reference to FIG. 2, 3, 4, 5 of unit A of the system, the compressed gas 30 temperature of about 800-950 (C) exact, may not be reached at the very first compression in compression chamber 28. Since the adiabatic temperature increase is directly correlated to the pre-compression 29 initial gas temperature, a high pre-compression temperature increases the efficiency of pressure and temperature increase of each compression that follows. After only few repeated compressions; a higher temperature and thermally stable compressed gas 30 at the range of about 800-950 (C) can be generated by the periodic repetition of compressions that also regularly receives the auxiliary increased temperature feedback gas 126 at 750 (C) from auxiliary compressor volume 46. Thereby, the frequency of compressions can be regulated and made optimal in the long run, further resulting in the decrease of the wear and tear and in an optimal efficiency due to the minimized operational input energy used.

For the calculation of the pressure, following fifth formula applies:
5 1.40
   P2=P1(v1/v2)=(1.0×10 Pa)(21)>70 atm (7 Mpa.) (5)
(If compressed air-gas is used with Gamma=1.40 and the initial temperature is 40 degrees (C), with initial pressure of 1 atm.
The network W done by the working gas, can be approximated by the following sixth formula: (Basis the internal energy U.)
   U2−U1=Delta U=Q−W. (Q+Energy added, W=Work.)
   U2−U1=U=−W (6)

(For the heat source, the compressed gas, it is initially adiabatic, then iso-volumetric. The adiabatic compressions are periodically repeated.)

With reference to FIGS. 2, 3, 4, 5 and 6 of unit A, when the working gas 113 attains thermal equilibrium and becomes superheated steam 113 at 700 degrees (C,) this working gas 113 is distributed through the insulated output pipe 97. First, in topping cycle with high pressure through steam turbine 99 and then with reduced temperature at about 400 degrees (C) and lower pressure through the past turbine closed cycle circulation pipe 111 to radiators 114, the working gas 113 also provides heating of premises 115. Then working gas 113 returns to thermal storage liquid sodium volume 36 with lower than thermal equilibrium temperature, at slightly lower than 100 degrees (C) and at a lower pressure after having been circulated through all radiators 114, first re-enter the pre-heating unit 82—where the working gas 113 re-entry temperature is increased to 300 degrees (C) to avoid heat shock as it enters the thermal storage volume 36, then through the return pipe 81 into the spiral pipe section 35 to reach the thermal equilibrium with thermal storage volume 36, again.

The system would be monitored and controlled by a direct digital control (DDC) computer. System operation parameters are based on the following volumes and their pressure and temperature control and monitoring: (With the same numerals in the drawings:)

List of Reference Numerals of Volumes and Related Monitoring Devices

Volume 16 and 17: Hydraulic oil that transmits force applied within pipe 14 and 15 for transmitting the force applied—same for units A and B. Pressure sensors.

Volume 28: Pre-compression gas volume 29 that gets compressed by the piston 26 upper surface in this cylindrical compression chamber 28. Pressure and temperature sensors.

Volume 30: The compressed gas volume that is compressed to 1/21 of its initial volume 29, this gas volume in unit B is 69—fully decompressed gas in unit B is 70. Pressure, temperature sensors.

Volume of 35: The spiral pipes section 35-unit A, within which the working gas 113 circulates, where this section 35 is within the liquid sodium volume 36. Pressure, temperature and sensors.

Volume 36: The static thermal storage stabilization and heat transfer liquid sodium volume 36. Pressure and temperature sensors. Same for both A and B, as it is one combined volume. Volume 113 and volumes of 82, 99, 100-101 and 107-108, 111: The Radiators (114) and closed cycle district heating circulation pipe (111) and working gas (113,) that runs within (111,) pre-heater unit (82,) and the steam turbine (99,) the double bypass pipes (100 and 101 and 107 and 108.) Temperature and pressure sensors, voltage regulators for the generator turbine power output and mechanic switches and electronic controls.

Volumes 46 and 78: Utilized to further increase 50% of volume of the compressed gas 30 pressure and temperature that is transferred into auxiliary compressor volume 46 to be re-supplied back from this hot gas feedback auxiliary compressor volume 46 into gas volume 29, after second compression within compression chamber 28. Identical two units for A and B. Main function is to increase already high temperature gas and directly conduct heat through its steel tube section 123 and 124 into thermal storage volume 36. Secondary function is to provide hot feedback gas into the pre-compression gas 29 within compression chamber 28. Volumes 46 and 78 have their own compression working pistons 45, 77. Pressure sensors and regulators and temperature sensors, electronic controls.

Volume of 85, 88: Is the service hot-water output pipe line 88 and service hot water thermal storage tank 85 volume, service hot-water, water input pipe 90. Pressure and temperature

Volume 91: The refrigerant of Freon type that runs within coil volume 93. Temperature and pressure sensors.

Volume 92: The partially insulated oil tank volume for heating the refrigerant gas 91. Temperature sensors.

Volume of 93: Refrigerant gas 91 heating coil volume that runs within an insulated oil tank 92 at 70 degrees (C) stabilized and increases the refrigerant of Freon type temperature within coil section 93 to 65-70 degrees (C.) Temperature and pressure sensors.

Volume of 94: A set of refrigerant coils for heat dissipation. Temperature, pressure sensors. Volume of chilled water tank 116: Central air conditioning chilled-water storage unit. An external chilled-water unit 116 for central air conditioners, where water cools to 4.4 and 7.2.degress (C.) Temperature sensors.

Volume of 117: Chilled water pipe that runs throughout the building and connects to the air handlers in the buildings and/or commercial premises. Temperature sensors.

Volume of 120: The hydrogen production component volume. Pressure and temperature and density sensors and all hydrogen related sensors and electronic control devices and at least two methods of hydrogen storage means of chemical bonding.

Volume 126: The compressed gas 30 that enters into the auxiliary compressor volume 46 and is compressed a second time with a compression ratio of 1/17, starting at minimum 300 (C) pre-compression temperature.

Volume of 129: External pressure regulation unit with gas input-output valve 127 (A).

Volume 130: External pressure regulation unit with gas input-output valve 128 (B). Temperature, pressure sensors and electronic controls for both 129 and 130.

System operation conditions are based on two main phases:

1. Before base load: This is before reaching the temperature range of 700-875 (C) within the thermal storage liquid sodium volume 36. (1200-1400 C for second embodiment.)

2. Post base load: After the temperature of the thermal storage liquid sodium volume 36 reaches 700-875 (C) range is stabilized. (1200-1400 C for second embodiment.)

The data coming from these sensors would be monitored continuously by the computer-direct digital control (DDC). Before the base load and peak load operation conditions are reached, the computer would do initialization with the following initialization seventh algorithm, based on the pre-compressed gas 29 and compressed gas 30 temperature readouts. Compressed state in unit A and decompressed state in unit B for example, and then vice versa; where compression repetition frequencies are equal and all wait periods are in terms of the compression-decompression cycles; where one cycle consists of four compressions per cycle of the large area piston 26, compressing-decompressing volume 28:

(Power On-Initialization):
Do (7)
If (shaft 4 is not in start up position, position shaft 4 to start up position);
Frequency=Get frequency (Compression Gas Temperature-T1 in volume 28);
Close valve (47);
Close valve (127);
Activate thruster (3) Start (to);
Wait (frequency to+t1=Compressed state 30));
Reverse thruster (3) End (t1);
(At the end of every second compression 30; wait period t1+t2 in compression chamber 28);

While for auxiliary compressor:
Open valve (47) (for gas input into auxiliary volume 46);
Reverse auxiliary thruster (40);
When thruster 40 is fully reversed;
Close valve (47);
Activate auxiliary thruster (40);
Wait (frequency t0+t1=Starting at the end of one compression wait+one decompression+one compression and wait+until ½ of next decompression of piston 26 is completed);
Open valve (47) (for gas feedback into volume 28);
Close valve (47);

(Right after gas input occurs into Auxiliary volume 46 volume);

For external pressure regulation volume unit:
Activate external pressure regulation compressor;
Open valve (127);
(After having supplied gas into volume 28 to avoid vacuum in decompression);
Close valve (127);
Wait (frequency t1+t2=Next decompression+one compression and wait+next decompression full completion+until the end of next compressed wait);
Reverse external pressure regulator unit compressor (132);
Open valve (127) (for in going gas back into volume 139);
Close valve (127);
Activate external pressure regulation unit compressor (132);
Wait (One decompression+one compression and wait+until end of second compressed wait);
Open valve (127);

(Repeat cycle);

(Concurrently in unit B: When unit A piston 26 completes compression, B side piston 66 is in the apposite decompressed state and the thruster 49 is ready to be re-activated for next compression);

While do
If (Compressed Gas Temperature (30)<300 C);
Frequency=A; (High frequency: Every 12 minutes.)
Else if (Compressed Gas temperature (30)<550 C);
Frequency=C; (Middle frequency: Every 15 to 25 minutes.)
Else if (Compressed Gas Temperature (30)<800 C);
(Second embodiment: Else if Compressed Gas Temperature 30<1300 C);
Frequency=E; (Base load frequency: Every 25 to 35 minutes.)

(Repeat cycle.)

As unit A is compressing, unit B is decompressing, and when unit B is in compressing, unit A is decompressing. Hence, two or more units have the utility and functionality of one, or in the case of more than two units; more than one unit, always being in a state of conducting thermo-physical energy into the single thermal storage volume with respect to time with continuity, while the other(s) is/are at the decompressed state and get ready for next compression. Whereas, in a single unit, due to the inevitable de-compression periods, energy conduction periods would be interrupted for long periods. The maximum temperature that can be reached is both a function of frequency of repeated compressions and the number and frequencies of the auxiliaries. For example, the number of auxiliaries could be increased to a maximum four. Therefore, in the second embodiment, a maximum high compressed gas temperature slightly greater than 1400 (C) can be reached within compression chamber 28. The second embodiment heat conduction interface has to be strengthened steel.

The initialization and then gradually reaching the desired base load temperature of compressed gas 30-in units A and B, provides a gas temperature range of 800-950 (C) in each of the units A and B, and therefore the single thermal storage-liquid sodium volume 36 temperature of 700-875 (C) would be stabilized due to specified time interval repeated heat supply that would be provided by both units A and B. Wherein, both contribute heat input into a single-common thermal storage volume 36 through the heat conduction by the steel interfaces 31 and 71. About 6% average loss would occur from the average of the 800-950 degrees (C) gas temperature range within the compression chamber 28. Reduced loss is possible due to the combined input of both units A and B into a single thermal storage volume.

A static oil volume of hydrocarbon or carbon-tetrachloride type fluid or molten nitrate salt or combined molten salt and oil/rock or liquid sodium. All of these have a higher average density (kg/m), higher heat capacity (cal/C), higher average heat conductivity (W/m K), higher average heat capacity (kJ/kg K) and higher volume specific heat capacity (kWh/m) values than water, if once-one of these materials reach a high threshold temperature. Hence, one of these choices would establish a thermal storage and stability volume, once a threshold temperature is stabilized. What is meant by thermal stability as related to specific heat capacity is defined by the following eighth formula:
c=Q/Delta T/m. (8);
where Q is expressed in calories, it is the fact that it would take considerably less energy for example, the (kcal) of heat-once a threshold high temperature is stabilized, to raise or keep the temperature at a certain range of a said fluid mentioned above, as compared to the heat input needed to raise the temperature of another reservoir of equal mass.

After base load conditions are reached, the computer would start operational and monitoring functions with the ninth algorithm that is based on the single thermal storage liquid sodium 36 temperature instead of the pre-compression gas volume 29 and the compressed gas volumes 30 temperature readings, as follows:
While not stopped (9)
Temperature=Thermal Storage Temperature-T1 (to);
Frequency=Get frequency (Thermal Storage Temperature);
Close valve (47);
Activate thruster (3) Start (to);
Wait (frequency to+t1=First period compressed state 30));
Reverse thruster (3) End (t1);

Repeat Cycle for second compression:
Activate thruster (3) Start (t1);
Wait (frequency t1+t2=Second compressed state 30);
Open valve (47) (outgoing gas from volume 28 into auxiliary volume 46);
Reverse thruster (3) End (t2);

While for auxiliary compressor:
Reverse thruster (40);
When valve 47 closes;
Open valve (127) (vacuum avoider gas in from volume 139 into volume 28);
Close valve (127);
Activate auxiliary thruster (40);
Wait (frequency t0+t1=One decompression+one compression and wait+until ½ of one decompression of piston 26 is completed);
Open valve (47) (Feedback gas into volume 28);
Close valve (47);

At next fully compressed state of piston 26;

For external pressure regulation volume unit 129;
Open valve (127) (Gas volume supplied back into volume 139);
Close valve (127);

(Repeat cycle);
(Activate thruster 3);

While do
Power Generation=Get Power Output (e);
If (Power Output>Optimal e);
Keep bypass valve (102) open and bypass valve (103) closed;
If (Power Output<Optimal e);
Close bypass valves (102) and (103);
If (Heat Generation<Optimal T);
Open bypass valves (102) and (103);
Else if (Thermal Storage Temperature>875 C);
(Second embodiment: Else if Thermal Storage Temperature>1400 C);
Set frequency=G; (Overheated frequency: Every 35 to 45 minutes.)
Or (Optional);
Set frequency=I; (System overheats—second option: Full stop-until restart.)

This system offers very important advantages as compared to a small nuclear power systems or coal plants for example. The invention enables a fully secure control method against overheating and related accidents, as indicated in last line of above algorithm and completely avoids air pollution. There is no risk of a disastrous event, as there are with the nuclear reactors. There are no waste products; therefore no additional costs are involved.

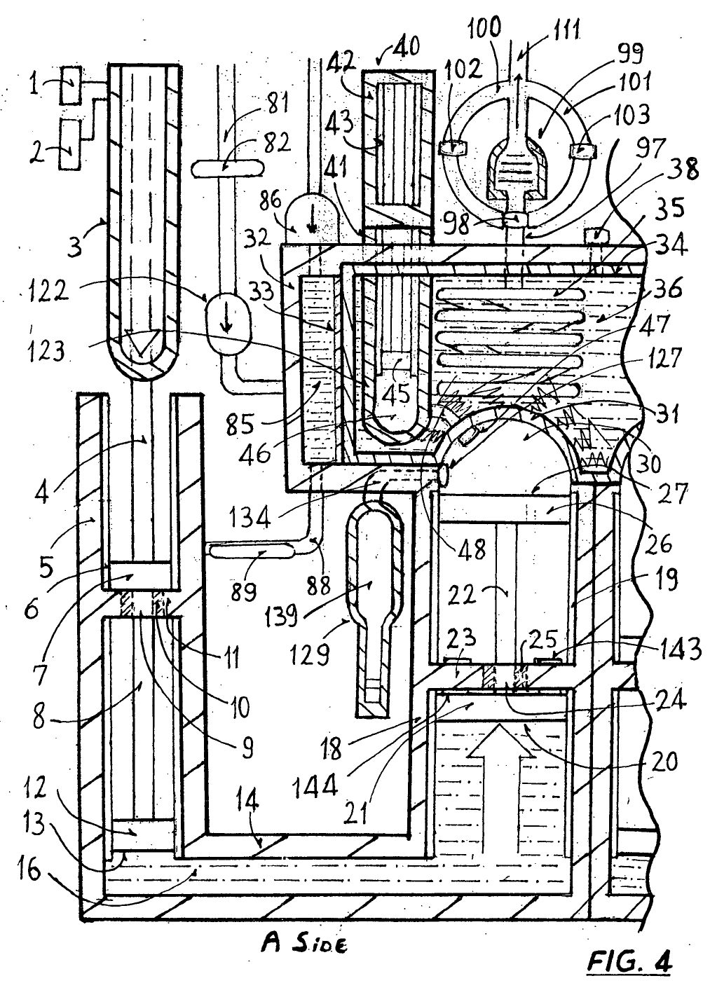

With reference to FIG. 4, it is an cross sectional view of unit A of the compression side of the system, showing how after the piston 26 compression compresses gas volume 29 into volume 30, heat conduction starts and heat is conducted into the heat storage liquid sodium volume 36, through the dome steel heat conduction interface 31. The upper side of compression piston 26 is made of a non-heat conductive material.

With reference to FIG. 4 again, the compressed gas 30 with increased pressure and temperature, initially an adiabatic process for the gas compressed 30, then becomes iso-volumetric; as the volume of the compressed gas state 30 remains iso-volumetric and does not change during the heat conduction period.

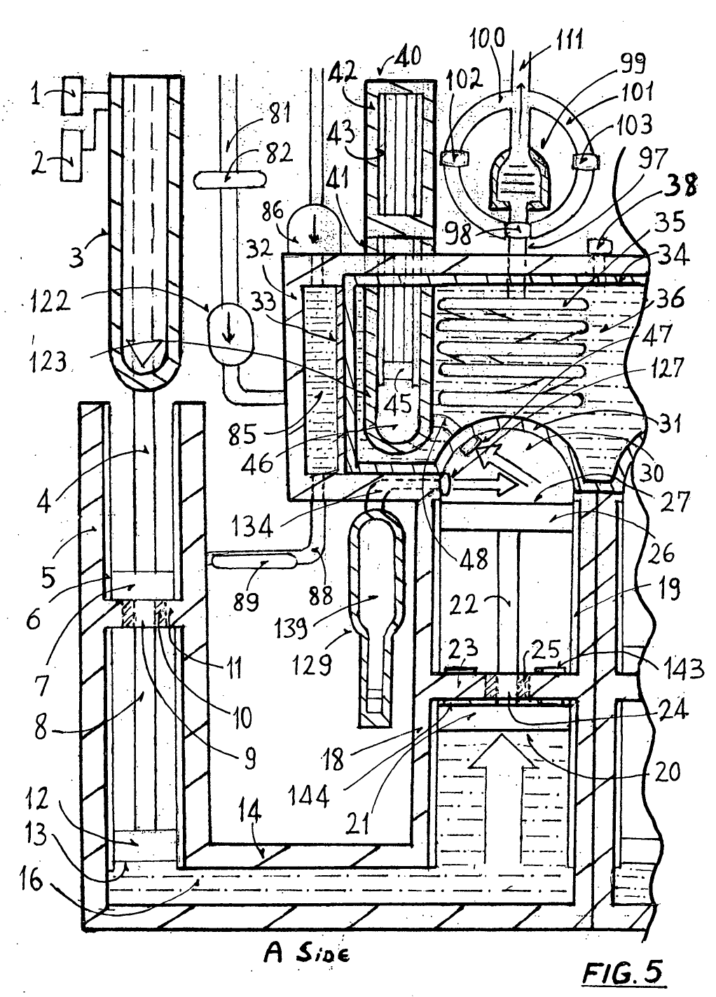

With reference to FIG. 5, in cross sectional view of the system unit A, (unit B is identical,) shows how before the compression large area piston upper side 26 starts to move to the decompression position and makes gas volume 30 to be decompressed back to gas volume 29, it is still at the last minutes of compressed iso-volumetric state 30 conduction period. Initial adiabatic high gas temperature range of 800-950 degrees (C) declines to about 300 degrees (C) at the end of this heat conduction period within volume 28. In order to avoid a vacuum condition within volume 28, as the piston 26 makes the next decompression move, an equal gas volume has to be transferred into volume 28 to make up the difference for the gas volume that has been transferred into the auxiliary volume 46. This occurs concurrently, out of volume 28 and into auxiliary volume 46 and an equal volume gets into volume 28 from the external pressure regulation volume 139 unit 129 (A), at 40 degrees (C) through the pressure regulation and gas input-output valve 127.

Again referring to FIG. 5, while valve 47 opens, the piston 45 of the auxiliary compressor 41 is moved to decompress the auxiliary compression volume 46 by the electro-mechanic thruster 40 reversal of the auxiliary compressor 41. These occur when the iso-volumetric heat conduction period from gas 30 within volume 28 into thermal storage volume 36 through the heat conduction dome steel interface (A) 31 is completed.

Again referring to FIG. 5, the high temperature gas 126 at 1500 degrees (C) within the auxiliary compressor volume 46 is not re-supplied into volume 28 for a period of three compressions of piston 26. Instead, at the iso-volumetric state, it is kept within volume 46 and the heat is conducted through the steel interface tube sections 123 (of unit A, identical in unit B) of the auxiliary compression volumes 46 that are located within the heat storage volume 36.

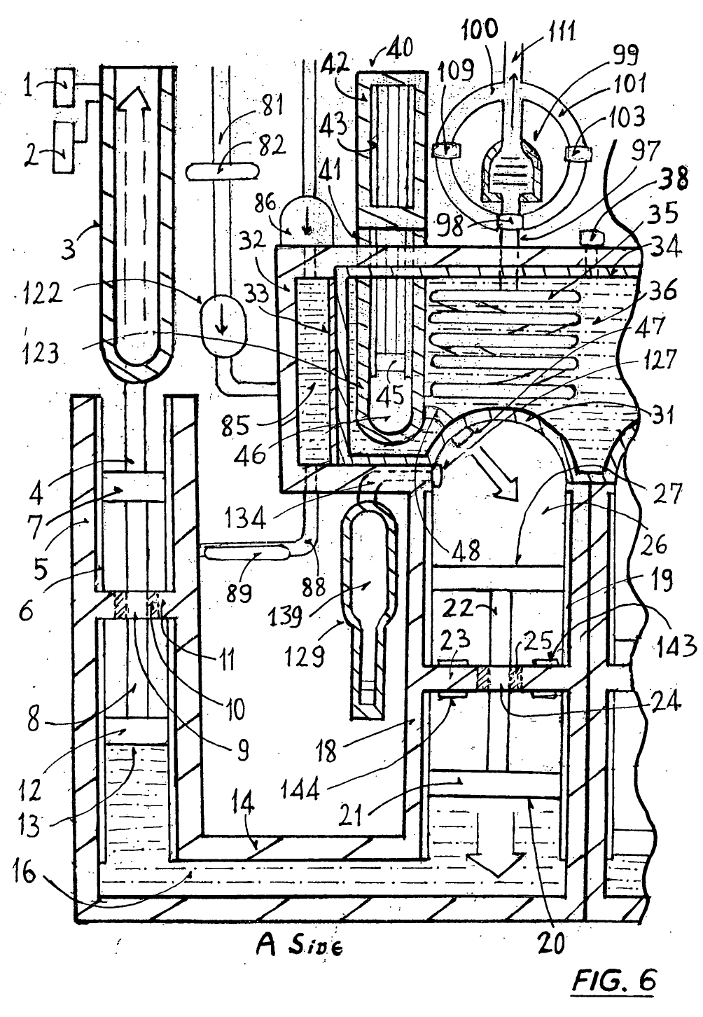

With reference to FIG. 6, in cross sectional view of unit A, it shows how the hot feedback gas 126 entry from the auxiliary compressor 41 that passes through input-output valve 47 and is re-supplied into the decompressing volume 29. While the thruster 3 (A) is in the reversing move, and therefore piston 26 is half way through the decompressing of the compression chamber volume 28. After the heat is transferred through conduction into thermal storage volume 36, at the end of the heat conduction period of three compressions and two decompressions, at third decompression, input-output valve 47 re-supplies the compressed gas 126 within the auxiliary compressor volume 46, and becomes the feedback gas 126 at 750 (C) that is re-supplied from auxiliary compressor volume 46, back into the volume 28. This occurs after every other three compressions of the large area piston 26, when it is ½ through third decompression within the compression chamber 28. Working gas 113 closed cycle insulated return pipe 81 returns through the pre-heater unit 82 and working gas return pipe 81 returns into the thermal storage volume 36 to attain thermal equilibrium with the thermal storage volume 36, again.

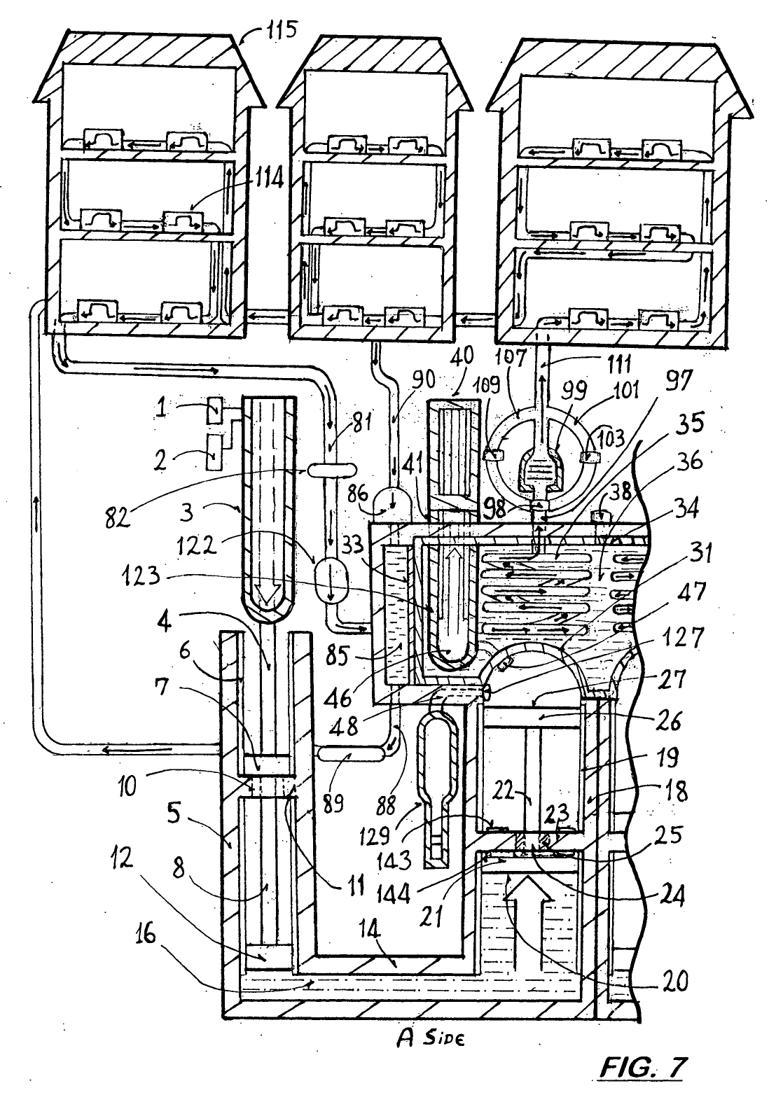

With reference to FIG. 7, in cross sectional view of unit A, shown is the service hot-water pipe line 88 and service hot-water heat transfer and thermal equilibrium tank 85 that is located around the other ½ cylindrical surface area of the thermal storage-stability oil volume 36, service hot-water-water input is provided by pipe 90 with pre-heater 86.

With reference to FIG. 7, again, in cross sectional view of unit A, it shows how the circulation steam 113 moves within the spiral section 35, that reach thermal equilibrium with the liquid sodium volume 36, as it passes within spiral section 35 through the thermal storage volume 36 and then first goes through the steam turbine 99 and then reaches the radiators 114 as working gas 113 of the residential and/or commercial buildings 115 and returns within a closed cycle insulated pipe 81 through the pre-heat unit 82, so that when it enters the thermal equilibrium environment within thermal storage volume 36, via return pipe 81, it reaches the thermal equilibrium condition with the thermal storage liquid sodium volume 36, in a shorter time and avoids a heat shock.

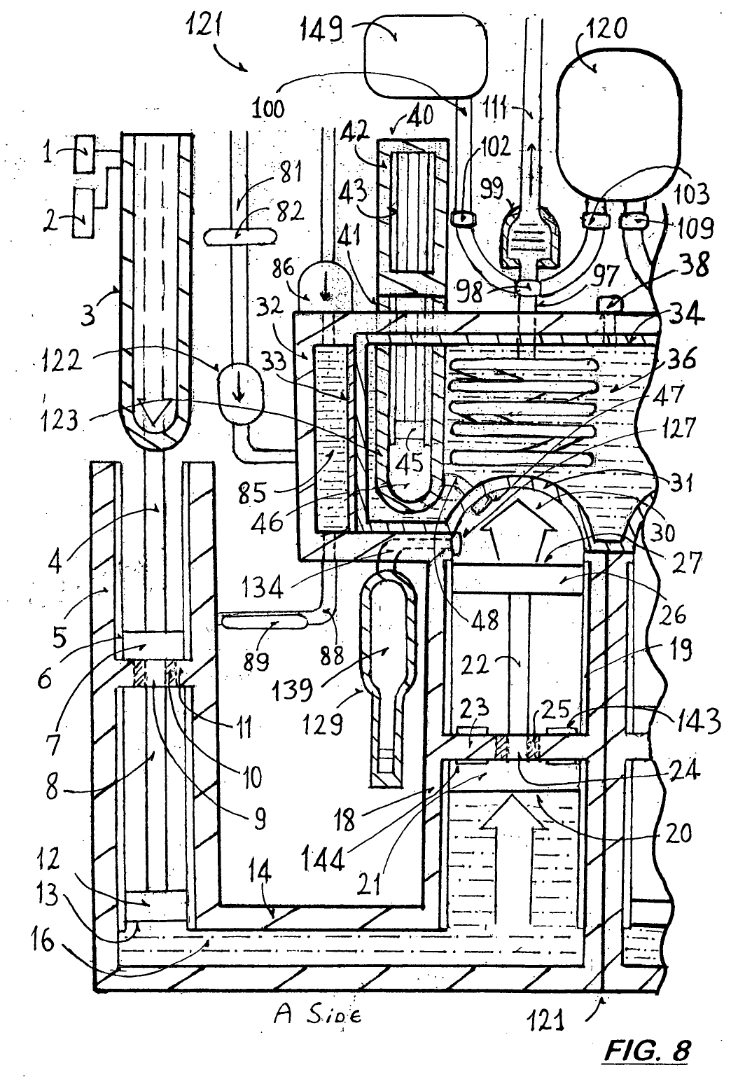

With reference to FIG. 8, it is a cross sectional depiction of the system unit A, that shows the hydrogen generation component 120 that is an integrated unit and includes: a. The water electrolysis means of hydrogen generation, b. The high-temperature steam hydrogen generation means, c. Carbon nanofibre technology and related means of hydrogen storage, d. A multi-metal hydride hydrogen storage means. The secondary hydrogen generation device 149 uses natural gas and is a separate unit, all are parts of the second embodiment cogeneration power generation plant 121 for electricity generation and mass production of hydrogen. Note, bypass pipe 100 in the second embodiment connects to the hydrogen generation device 151 and steam allocation between turbine 99 and integrated hydrogen unit 120 is regulated by valves 98 and 102, 103 (of unit A side.)

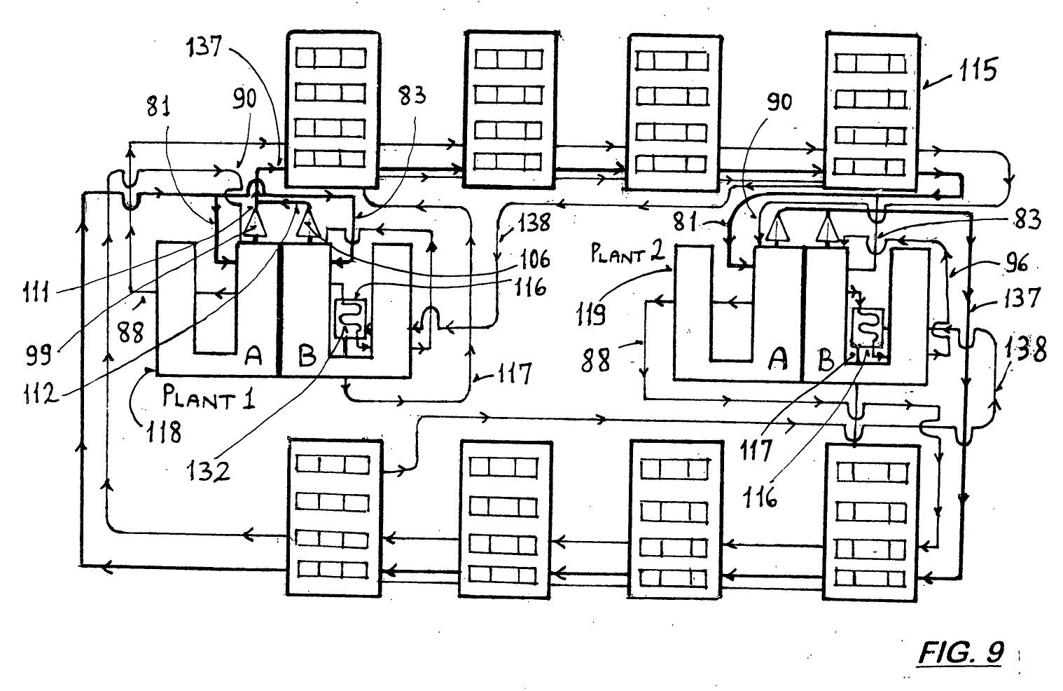

With reference to FIG. 9, it is an illustrative depiction of a multiple number of plants, in a network setup of this invention, where system can be established of several plants adjacent to each other, or at a certain optimal distance on the central heating wide area, so that each complements the other for higher capacity applications and optimal efficiency. Each system can have a wide range of capacities, with at least 20 MW for first embodiment, and at least 500 MW capacities for the second embodiment. Therefore, the system can provide customized solutions based on application area specific needs and requirements, whether the need is very large scale or small. Where more than one system that consist at least of the pair of units A and B of cogeneration plants 118 and 119 complement each other for high capacity and wider area applications, supplying heat and electricity to residential and/or commercial buildings 115. Note; the two separate working gas input pipes 111-112 unite into one central heating closed cycle distribution pipe 137.

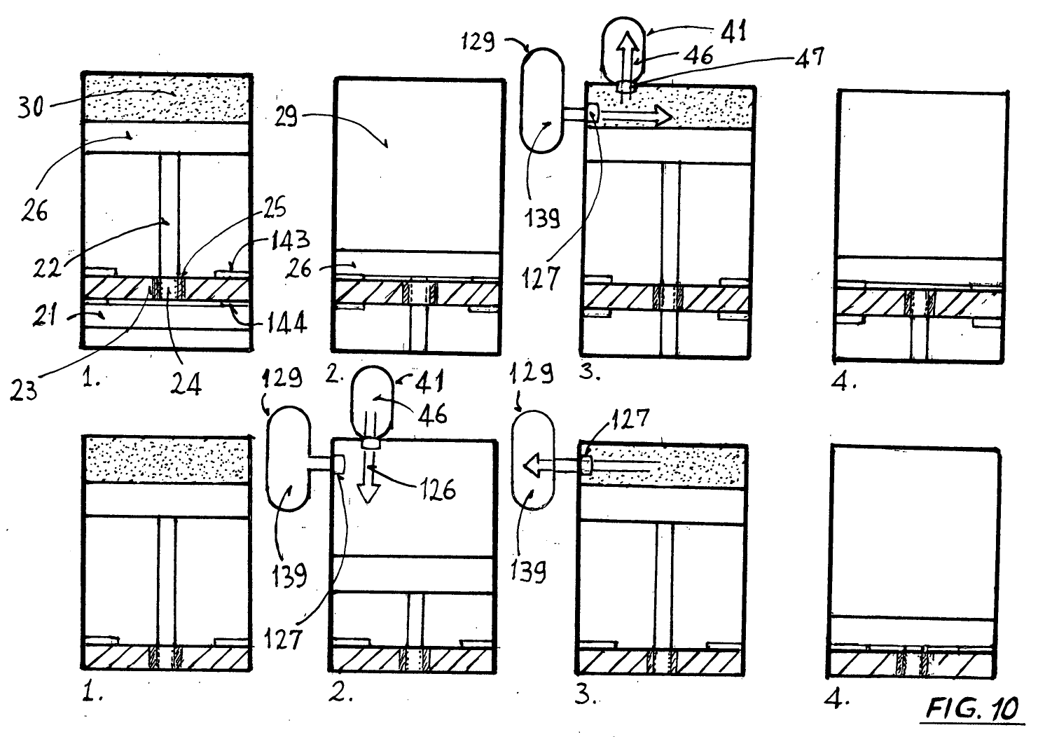

With reference to FIG. 10, it is an illustrative depiction of the large area piston upper side 26 and lower side 21 and the sequence of the cycle of compressions and decompressions that is based on four compressions per cycle, and the gas input-output timings that occur with the auxiliary compression volume 46 and with the external pressure regulation unit volume 139 through the gas input-output valves 47 and 127 respectively.

Furthermore, in addition to two units A and B, unit C, or C and D and units E and F can be added to make the system to consist of triple or of quadruple units or make the system to consist of six units. Such greater than two unit configuration is mentioned in claim 16b. Thereby, greater than 1500 MW capacity plants can be build.

The Central Air Conditioner Chilled-Water Unit and the Summer Mode

The liquid sodium in the thermal storage volume 36 must be kept at a minimum temperature range of 550-650 (C). Sodium freezes at 208 F (97.68 C.) Therefore, the thermal storage volume 36 temperature must never decline below a minimum 300 (C.) For the optimal use of the thermal storage 36, that functions as the thermal storage with an internal heat transfer volume-made of the spiral working gas pipe sections 35 and 39, the temperature of 300 (C) is not useful. Therefore, the lowest operational temperature is 650 (C.)

The hot thermal storage volume 36, enables refrigerant working gas 91 hot coil 93 to be heated to 70 (C) within the externally insulated-internally waste heat utilizing oil volume 92, which surrounds ½ of the external cylindrical surface area 87 of the liquid sodium volume 36. Instead of the conventional compression of a compressor, waste heat of the thermal storage volume 36 is utilized to increase temperature of refrigerant gas 91 to 70 (C.)

The demand for service hot-water remains the same or even increases during summer months. Hence, energy to heat the service hot-water thermal equilibrium tank 85 has to be provided throughout all seasons. The utilization of the waste heat from the thermal storage volume 36, for both central air conditioning chilled-water unit 116 and to provide heat for the insulated service hot-water tank 85, and provide power cogeneration with the steam turbines 99 and 106, makes the system be utilized throughout the year and highly efficient.

Since central heating function would not be operational during summer months, most of the working gas-steam 113 would be available for the production of power. This would further shorten the period of return on investment, as the electricity can be sold on a contract basis to a user outside of the host facility.

### Investment Feasibility

With respect to the power and cogeneration plant investment feasibility, following equation is used to evaluate the investment worthiness, based on the determination of present value of the power plant kWh output average cost, as follows:

Let the total life of the plant, of which the construction would have been started “n” years before it starts power generation, be set as “T”, where it would be connected to the power grid at year t0. Let the capital cost that would be added for each year, with company funds and credit funds and credit financing costs and operational and fuel costs in the “n, T” period, be set as d(t). The capital financing costs would be started from “−n” year and the fuel costs would enter the equation only after the plant becomes operational. Then, basis the “t0, T” period, let kWh production that would occur every year be set as E(t). It is assumed that the entity that makes the investment correctly predicts the base load throughout the plant life and is also able to calculate the yearly production that can be sold for each year. Thus, the present value of each kWh of the plant production at “t0, T” period, would be set equal to the present value expenditures that would occur at “−n, T” period, such that, by assigning a constant value C, that is equal to the present value expenditures that would occur at “−n, T” period. The aim is to determine the plant output of the average cost of 1 kWh. The entire calculation is made by using a national proportion “a” for the starting year “t0”, by using a basis of present value determination, with a constant price. The present average cost and hence determination of price of the kWh of the plant output, excluding taxes, is derived by the following tenth equation:
C=(Sigma.sub.t)=n, (Sigma.exp.T)×D(t)/(1+a).exp.t/(Sigma.sub.t)=0, (Sigma.exp.T)×E(t)/(1+a).exp.t=Present value of total expenses/Present value of total production value (kWh.) (10)

Due to the feature of the independence from fossil fuels, and the ability to utilize both renewable operational energy input and operational energy input from utility grid that can be multiplied by the invention system, the operational and fuel costs d(t) would be a very small value and negligible. Thus, return on investment can be realized in a shorter time.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications, especially of above indicated more than two coordinating and combined system units of compression means and within the legitimate and valid scope of the amended claims, appropriately interpreted in accordance with the doctrine of equivalents.

The device and the methods mentioned heretofore have novel features that result in a new device and method for high efficiency cogeneration and second embodiment cogeneration-hydrogen mass production system, that are not anticipated, rendered obvious, suggested, or implied by any of the prior art cogeneration systems, either alone or in any combination thereof.

What is claimed is:

1. An energy conversion system made of at least two units of A and B working in coordination, for use by the thrust of steel shafts that are regularly activated by an energy source coupled to electromechanical means of kinetic motion, to convert and multiply the force applied at least three fold per one shaft, that have two phases of thrusting speeds of said steel shafts; into usable thermal energy comprising:
a. at least one pair of steel shafts of linear kinetic-motion capability that provide sudden thrusting motion regularly, in order to move a first piston side in each of units A and B; and A and B are identical;
b. at least a pair of first piston/cylinder combinations, each said cylinder including a pair of first working chambers wherein upper and lower sides of small area pistons move within;
c. at least one pair of second piston/cylinder combinations with a second working compression chambers located between second pair piston upper side and high pressure resistant enclosed compression chamber, with dome heat conduction interfaces that are located at the top of the said compression chambers of the second pair cylinders; and said first and second pair small and large area pistons have fixed platforms between the upper and lower piston sides, that have stoppers attached on upper and lower sides and therefore function as stoppers for both pairs of upper and lower side pistons and said second pair piston/cylinder combination and second pistons are of a pre-determined diameter size larger than the said first pair piston/cylinder combinations;
d. the pair of first pistons, lower piston side of said first pair piston/cylinder combination is connected to second lower side of said pair piston/cylinder combination via a hydraulic oil link;
e. at least one pair of steel shafts to thrust and then re-position the upper sections of said first pair pistons that are connected to said shafts within the first working chambers;
f. at least one pair of electro-mechanic means connected directly to said shafts, with two phase of thrusting speed of the kinetic motion of thrust, in which the first phase startup is very slow to avoid wear and tear and vibration; and the second phase is very swift that makes up the majority of the kinetic motion; and the direction reversal is a slow regulated motion that re-positions the said first pair pistons back to their initial pre-thrust positions to enable repeat thrusting motions;
g. at least one pair of direct heat conduction metal medium that conduct thermal energy from the compressed—high temperature compression chamber gas, made of dome steel interfaces, each providing the means of an enlarged dome area for heat conduction, which are in communication with said second working chambers for heat conduction transfer means from the second working compressed gas inside the compression chambers, into said volume of single thermal storage liquid sodium and/or chemical variants thereof; which contains the heat exchanging spiral steel pipe sections of the working gas circulation pipe within;
h. said thermal storage fluid heat exchanger within the steel cylindrical container contains a volume of liquid sodium and/or chemical variants thereof, that does not change from the liquid phase;
i. said thermal storage volume steel cylindrical container has an inlet—filling and a drainage outlet pipe and can utilize either liquid sodium and chemical variants or a high temperature durable oil based medium and provides the means for change of one medium with a different one that can be utilized by interchanging the different mediums, as well as for changing the same type of medium for the periodic maintenance;
j. at least one pair of high temperature gas auxiliary compressors that are located within the thermal storage container and fixed in a position within the liquid sodium volume and that are capable to transfer compressed gas in and out from the compression chamber, and have the secondary function to provide high temperature feedback gas for the compression chamber, and have the primary function to conduct heat directly through their steel tube interfaces, when gas is compressed within their volume, into the thermal storage volume periodically;
k. at least one pair of external pressure regulation units;
l. at least four gas input—output valves that are between the compression chamber steel enclosure walls and auxiliary compressor units, as well as external pressure regulation units, which manage the periodic gas in and outflow between the compression chambers, and said auxiliary compressor units and communicate gas between compression chambers and external pressure regulation units,
m. at least one pair of spiral fluid—working gas pipe circulation sections that circulate and are located within said thermal storage liquid sodium for heat exchange with the same,
o. at least a service hot-water tank located against the external surface area of the steel frame wall of the thermal storage container and covers around the ½ circumference of the thermal storage volume cylindrical external surface area of the said frame, for waste heat utilization; and provides water heating that is based on a year round load averaged over 24 to 48 hour period and delivers a pre-selected 65 degrees (C.) to a hot water output, like a shower, dishwasher, washing machine or other appliances;
p. at least a hot oil tank with 70 degrees (C.) stabilized oil temperature that contains the refrigerant coils circulating therein; and likewise is located against the external surface area of the steel wall of the thermal storage container and covers around the other ½ circumference of the thermal storage volume cylindrical external surface area of said frame; for waste heat utilization and for the refrigeration cycle that provides chilled water to the chilled water unit for air conditioning.
q. integrated electrolysis devices that utilize the very low cost electricity and heat generation that are coupled to the electric generator of the steam turbine and also coupled to working gas circulation pipe, and associated safe hydrogen storage devices and means;
r. a secondary hydrogen generation device that is based on the chemical affinity of hydrogen with carbon, and associated safe hydrogen storage devices and means.

2. The system of claim 1, wherein said energy source coupled to said electromechanical means is from a renewable energy source, and to secure an uninterrupted operational energy input and to avoid a possibility of energy input of intermittent nature:
a. said electromechanical means is also coupled to the main utility grid for operational energy input, and;
b. the generators of the system have the means to operate in parallel with the utility grid; and the electricity generated can be sold on a contract basis to users outside of the host facility; since the system satisfies the qualify facility (QF) status based on the following requirement given by the eleventh and following twelfth derived equations: Requirement;
Power output+½ Useful Thermal Output/Energy Input≧42.5% (in one year); (11)
and for the invention system the above equation reads instead:
Power output+½ Useful Thermal Output/Energy Input>>42.5% (in one year); (12);
therefore invention system exceeds the basic requirement.

3. The system of claim 1, wherein the system construction time and less complicated production means of the apparatus of this invention, makes it possible to realize a short period of system construction completion and combined with the relatively low initial investment cost and as a result of establishing a reliable long-lived power plant with long-lived earnings potential; enables the return on investment to be realized in a substantially shorter time; at least four to five years earlier as compared to comparable capacity combustion and nuclear power plants.

4. The system of claim 1, further comprising of dome structured steel-alloy interfaces that increase the area for direct heat conduction means, and are in direct heat transfer communication with said compressed heated gas, into the single thermal storage liquid sodium volume on a regular basis and are located in between said thermal storage liquid sodium volume container bottom and above said compression chambers.

5. The system of claim 1, wherein the said thermal storage cylindrical container further contains one pair of spiral steel pipe sections of the working gas closed cycle distribution pipes, immersed inside the single thermal storage liquid sodium volume, and enables the circulation of the working gas within the spiral pipe sections, through the thermal storage volume.

6. The system of claim 1, wherein said cylindrical container external surface area of the thermal storage volume communicates waste heat into the:
a. service hot water tank, that is around the ½ circumference of the thermal storage volume steel cylinder frame, as well as into;
b. the oil tank that contains the refrigerant coils circulating therein, located around the other ½ circumference of the thermal storage volume cylindrical structure, with a refrigerant circulation hot working gas coil section, that circulates within the oil tank volume and said oil tank faces the other one half circumference of the non-circulated single thermal storage liquid sodium volume external steel enclosure cylindrical surface area that utilizes the waste heat thereof, to heat up the refrigerant gas therein and provides a refrigeration cycle to provide cooling for a chilled-water based central air conditioning during summer months, and said thermal storage cylindrical external surface area;
c. further comprises a heat conduction semi—insulation layer that conducts waste heat at a certain limited rate, that is in between the said service hot water tank and said oil tank internal surface wall, that face the thermal storage volume cylindrical external wall, and covers the entire circumference of the steel cylindrical frame of the thermal storage volume for the waste heat conduction means.

7. The system of claim 1, wherein said pre-determined diameter large pair of piston/cylinder combinations, are three times the diameter of said smaller pair of piston/cylinder combinations.

8. The system of claim 1, wherein said hydraulic links comprise of hydraulic oil.

9. A method of generating thermal energy from the regularly repeatable kinetic motion of four or more thrusters and shafts coupled to said small area pistons that move within small diameter cylinders, comprising the steps of:
a. connecting second side of system units A and B or more than two units small diameter piston/cylinder combinations via hydraulic links to second sides of a larger diameter piston/cylinder combinations;
b. adiabatically compressing a gas on a upper side compression chamber of said second large diameter non-conducting piston/cylinder combinations of unit A and B or more than two units, by placing a first sides of said small diameter piston/cylinder combinations in communication with the means of exerting the kinetic motion force thereon provided by the electro-mechanically moved shafts of unit A and B or more than two units, on a regular basis;
c. conducting heat from said heated gas within the compression chambers of unit A and B or of more units, into the single liquid sodium volume thermal storage volume that above said compression chambers, by using the dome heat conduction steel surface areas of units A and B or of more units; in order to establish a single highly stable volume of thermal storage liquid sodium and chemical variants thereof; into which both units of A and B, or of more units establish a means of coordination for a means of continuity of providing thermal energy input on a regular basis;
d. the coordinated compressions-decompressions in units A and B or of more than by the slower direction reversal of the pair of electro—mechanically initiated motions of said shafts;
e. circulating said pair of working gas spiral pipes within said single thermal storage liquid sodium volume and transferring said high pressure working gas with greater than 1500 psig—generated within the spiral pipes section, in a topping cycle through a steam turbine and then through a closed cycle working gas pipe that is connected to radiators, with a flexible allocation means of steam power for the power generation turbines or for the central-district heating circulation, and usually to establish an optimal balance between power generation and heating needs; is adjustable based on the site—specific cogeneration needs;
f. one pair of high temperature gas auxiliary compressors that communicate already hot compressed gas from and back to the compression chambers, and have the secondary function to provide high temperature feedback gas for the compression chambers of units A and B or of more units, and are located within the thermal storage volume, and have the primary function to conduct heat through their steel tube interface sections directly into the single thermal storage volume.

10. The system and method of claims 1 and 9, further including an integrated device and means to produce hydrogen in a plant with a capacity with at least 500 MW; by providing electrical energy and high temperature steam to the hydrogen generation means and devices, that can operate on a combined mode utilization of both the electricity that is generated at a very low cost of less than three cents/kWh—for:
a. the electrolysis of water means, that is integrated in one unit with;
b. the high—temperature steam hydrogen generation means, and; either one of the means alone is capable to independently produce hydrogen, and both means—utilized concurrently or not, are used for the mass production of hydrogen and;
c. a separate secondary hydrogen generation device that is based on the chemical affinity of hydrogen with carbon, which requires 71 (kJ/mol) less energy for the bond dissociation between C—H, relative to O—H, capable to dissociate hydrogen from Methane and Butane and other various derivatives of natural gas.

11. The method of 10, wherein the means for storing hydrogen generated, includes methods of bonding hydrogen chemically, which are the safest methods, such as advanced carbon absorption techniques of carbon nanofibre technology with improved lower temperature of decomposition and multiple metal hydrides type such as lanthanum—pentanickel hydride (La Ni5 Hx), where the hydride forming reaction in both; are exothermic and reversible and given by the following thirteenth and fourteenth formulas:
Carbon+hydrogen⇄Hydrocarbons+heat, (13)
Metal+hydrogen⇄Metal hydride+heat. (14)

12. The method of claim 9, wherein the step of placing said pair of small diameter/piston cylinders combination of the two units A and B or of more units, in communication with one pair of shaft thrusters further comprises using the said pair of steel shafts to provide thrusts on the first pair of small diameter/piston cylinders combinations, by the repeatable electro-mechanical kinetic force thrusting means.

13. The method of claim 9, further comprising the step of changing the direction of the motion of the pair of shafts which are coupled to the electro—mechanical thruster components on one side and are connected to the first sides of the small diameter pistons cylinders combinations on the other side, by slowly reversing the directions of the electro-mechanic shaft motion means after the said two phase forward thrusting motion and the associated wait periods for heat conduction are completed.

14. The method of claim 13, further comprising the step of repeating the cycles at pre-determined time intervals, which are adjustable by the computer for the base load, peak load and for all different load levels and is operated by a fully computerized direct digital control (DDC) system that monitors and controls mainly the conditions of:
a. the electro—mechanic thrusters of units A and B or of more units and of auxiliary units;
b. temperature and pressure in compression chambers of system units A and B or of more units, and;
c. the temperature and pressure in compression volumes of the auxiliary compressors;
d. the temperature stabilization of the thermal storage liquid sodium volume e. all other related mechanic components, electronic controls, voltage regulators and valves.

15. The method of claim 14, wherein the desired base load temperature of the said single-thermal storage liquid sodium is in the temperature range of 700-875 (C.)

16. The method of claims 9 and 10, wherein the step of conducting heat can have two different embodiments:
a. heat conduction from said repeatedly compressed gas through the steel interfaces of the two units of A and B, at the range of 800-950 (C) compressed gas—that also utilizes the auxiliary compressors hot gas feedback, increases the temperature of the said single thermal storage liquid sodium volume to a stabilized temperature of at least 700 (C), with the two units A and B that have at least two auxiliary compressors;
b. heat conduction from said repeatedly compressed gas, through the steel interfaces at the range of 1300-1500 (C) gas temperature—that also utilizes the auxiliary compressors input, increases the temperature range of the said single thermal storage liquid sodium volume to a stabilized temperature of at least 1200 (C), with more than two units A and B and C or of more units, and with at least two, or three or four or more auxiliary compressors, and for both embodiments; the cogeneration constant can be used to determine the rate of useful thermal energy and to make comparisons of thermal versus electrical of end needs, in therms/hour or in MW(e) respectively, given by the following fifteenth equation:
Q=E×Kc. (15)
(where E is the cogeneration system electrical rated capacity, Kc is the cogeneration constant.)

17. The system of claim 9, wherein the step of adiabatic compressions of gases on both units A and B or of more units, on the second side of said non-conducting large diameter/piston cylinder combinations, further comprises compressing the gases therein with at least initial 40 (C) pre compression temperature, with a compression ratio of minimum 1/17 and a maximum of 1/21 of their initial volumes that result in a 25 or a 30 fold increase of the temperature of said gases for both units A and B or of more units respectively, with each one compression.

18. The system of claim 1, wherein the thermo-physical means of the compression chambers and the highly stabilized thermal storage volume both provide high pressure gas volumes and the efficient thermal energy generation means and therefore enable:
a. to integrate and apply other energy conversion and generation devices with the means of gas dynamic pumping for CO2 laser systems and thermo—electric power generation sub-systems and magneto—gas dynamics, magneto—hydrodynamics; such as Magneto—hydrodynamic generator (MHD) and gas ionization and plasma physics related devices and catalytic conversion means and any improvements and advanced variants, means and modifications thereof; which can be utilized when integrated to the thermo-physical means of the invention system; which the OEM entities deem beneficial to integrate with the efficient thermo—physical means of this invention.
b. the high pressure gas and thermal energy generation of the invention system can be utilized for all other industrial processes and systems that require thermal energy utilization means.

19. The system of claim 1, wherein the cogeneration system size and capacity can be within a broad range; it can be as small as a mid to large size home appliance, such as a small capacity system for a single apartment unit or a single family house and can have a large capacity and size; as large as a large size power plant, and the system can be applied as a cogeneration system for large area commercial complex buildings or a large group of residential buildings.

20. The method of claim 16, wherein the cogeneration system size and capacity can be within a broad range; it can be as small as a mid to large size home appliance, such as a small capacity system for a single apartment unit or a single family house and can have a large capacity and size; as large as a large size power plant, and the system can be applied as a cogeneration system for large area commercial complex buildings or a group of residential buildings, as per claim 16b.
